(19) United States
(12) Patent Application Publication
(10) Pub. No.: US 2026/0082383 A1
(43) Pub. Date: Mar. 19, 2026

(54) METHODS AND APPARATUSES FOR DETERMINING HARQ PROCESS NUMBER

(71) Applicant: Lenovo (Beijing) Limited, Beijing (CN)

(72) Inventors: Ruixiang Ma, Beijing (CN); Haipeng Lei, Beijing (CN); Yu Zhang, Beijing (CN); Haiming Wang, Beijing (CN)

(73) Assignee: Lenovo (Beijing) Limited, Beijing (CN)

(21) Appl. No.: 18/993,854

(22) PCT Filed: Jul. 15, 2022
(86) PCT No.: PCT/CN2022/105991

§ 371 Date: Jan. 13, 2025

(51) Int. Cl. H04W 72/11; H04L 1/1812; H04W 72/231; H04W 76/20

(52) U.S. Cl. CPC H04W 72/11; H04L 1/1812; H04W 72/231; H04W 76/20

(57) ABSTRACT

Embodiments of the present disclosure relate to methods and apparatuses for determining hybrid automatic repeat request (HARQ) process number (HPN). According to some embodiments of the present disclosure, a user equipment (UE) may include: a processor configured to: determine at least two periodicities with different values for a configured grant (CG) configuration or a semi-persistent scheduling (SPS) configuration; determine an HPN for an uplink (UL) transmission corresponding to the CG configuration or a downlink (DL) transmission corresponding to the SPS configuration based on a reference parameter; a transceiver coupled to the processor and configured to: transmit the UL transmission based on the HPN; or receive the DL transmission based on the HPN.

### TECHNICAL FIELD

Embodiments of the present disclosure generally relate to wireless communication technology, and more particularly to methods and apparatuses for determining a hybrid automatic repeat request (HARQ) process number (HPN).

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

Extended reality (XR), including augmented reality (AR), mixed reality (MR) and virtual reality (VR), as well as cloud gaming (CG), presents a new promising category of connected devices, applications, and services. XR applications typically require high throughput and low latency. For an XR service, how to determine the HARQ process number has not been discussed yet.

### SUMMARY OF THE APPLICATION

Embodiments of the present application at least provide technical solutions for determining a HARQ process number for a configured grant (CG) configuration or a semi-persistent scheduling (SPS) configuration.

According to some embodiments of the present application, a user equipment (UE) may include: a processor configured to: determine at least two periodicities with different values for a CG configuration or an SPS configuration; determine an HPN for an uplink (UL) transmission corresponding to the CG configuration or a downlink (DL) transmission corresponding to the SPS configuration based on a reference parameter; a transceiver coupled to the processor and configured to: transmit the UL transmission based on the HPN; or receive the DL transmission based on the HPN.

In some embodiments of the present application, the at least two periodicities with different values are in a time window, and the reference parameter is a length of the time window.

In some embodiments of the present application, the at least two periodicities with different values are in a time window, and the reference parameter is the number of periodicities included in the time window.

In some embodiments of the present application, the length of the time window is in units of symbols, and to determine the HPN for the UL transmission, the processor is further configured to perform at least one of: determining a time window including a first symbol of the UL transmission; determining a periodicity including the first symbol of the UL transmission within the time window; or determining the HPN based on the periodicity including the first symbol of the UL transmission.

In some embodiments of the present application, to determine the HPN for the UL transmission, the processor is further configured to: in the case that an offset and a retransmission timer are not configured in the CG configuration, determine the HPN for the UL transmission based on the following equation: if CURRENT_symbol−floor (CURRENT_symbol/periodicity)*periodicity is larger than or equal to a sum of values of first i periodicities within the time window and smaller than a sum of values of first i+1 periodicities within the time window, HARQ Process ID=[floor (CURRENT_symbol/periodicity)*M+i] modulo nrofHARQ-Processes; and in the case that an offset is configured in the CG configuration, determine the HPN based on the following equation: if CURRENT_symbol−floor (CURRENT_symbol/periodicity)*periodicity is larger than or equal to a sum of values of first i periodicities within the time window and smaller than a sum of values of first i+1 periodicities within the time window, HARQ Process ID=[floor (CURRENT_symbol/periodicity)*M+i] modulo nrofHARQ-Processes+harq-ProcID-Offset2; wherein: HARQ Process ID is the HPN; CURRENT_symbol=(SFN×numberOfSlotsPerFrame×numberOfSymbolsPerSlot+slot number in the frame×numberOfSymbolsPerSlot+symbol number in the slot), wherein SFN is a system frame number of a system frame associated with the UL transmission, numberOfSlotsPerFrame refers to the number of consecutive slots per frame, numberOfSymbolsPerSlot refer to the number of consecutive symbols per slot, slot number in the frame refers to a number of a slot associated with the UL transmission, and symbol number in the slot refers to a number of the first symbol of the UL transmission; periodicity is the length of the time window; M is the number of periodicities included in the time window; i is a value from 0 to M−1; nrofHARQ-Processes is the number of HARQ processes configured in the CG configuration; and harq-ProcID-Offset2 is the offset configured in the CG configuration.

In some embodiments of the present application, the length of the time window is in units of slots, and to determine the HPN for the DL transmission, the processor is further configured to perform at least one of: determining a time window including a slot where the DL transmission starts; determining a periodicity including the slot where the DL transmission starts; or determining the HPN based on the periodicity including the slot where the DL transmission starts.

In some embodiments of the present application, to determine the HPN for the DL transmission, the processor is further configured to: in the case that an offset is not configured in the SPS configuration, determine the HPN based on the following equation: if CURRENT_slot−floor (CURRENT_slot/periodicity)*periodicity is larger than or equal to a sum of values of first i periodicities within the time window and smaller than a sum of values of first i+1 periodicities within the time window, HARQ Process ID=[floor (CURRENT_slot×10/(numberOfSlotsPerFrame×periodicity))*M+i] modulo nrofHARQ-Processes; and in the case that an offset is configured in the SPS configuration, determine the HPN based on the following equation: if CURRENT_slot−floor (CURRENT_slot/periodicity)*periodicity is larger than or equal to a sum of values of first i periodicities within the time window and smaller than a sum of values of first i+1 periodicities within the time window, HARQ Process ID=[floor (CURRENT_slot×10/(numberOfSlotsPerFrame×periodicity))*M+i] modulo nrofHARQ-Processes+harq-ProcID-Offset; wherein: HARQ Process ID is the HPN; CURRENT_slot=[(SFN×numberOfSlotsPerFrame)+slot number in the frame], wherein SFN is a system frame number of a system frame associated with the DL transmission, numberOfSlotsPerFrame refers to the number of consecutive slots per frame, slot number in the frame refers to a number of a slot where the DL transmission starts; periodicity is the length of the time window; M is the number of periodicities included in the time window; i is a value from 0 to M−1; nrofHARQ-Processes is the number of HARQ processes configured in the sPS configuration; harq-ProcID-Offset is the offset configured in the SPS configuration.

In some embodiments of the present application, the reference parameter is a value of one periodicity of the at least two periodicities.

In some embodiments of the present application, the one periodicity is the first periodicity in the time domain in the at least two periodicities; or the transceiver is further configured to receive radio resource control (RRC) signaling or downlink control information (DCI) indicating the one periodicity from the at least two periodicities; the one periodicity is a periodicity with a smallest value in the at least two periodicities; or the one periodicity is a periodicity with a largest value in the at least two periodicities.

In some embodiments of the present application, the transceiver is further configured to receive an indication indicating a value as the reference parameter.

In some embodiments of the present application, to determine the HPN for the UL transmission, the processor is further configured to: in the case that an offset and a retransmission timer are not configured in the CG configuration, determine the HPN for the UL transmission based on the following equation: HARQ Process ID=[floor (CURRENT_symbol/periodicity)] modulo nrofHARQ-Processes; and in the case that an offset is configured in the CG configuration, determine the HPN based on the following equation: HARQ Process ID=[floor (CURRENT_symbol/periodicity)] modulo nrofHARQ-Processes+harq-ProcID-Offset2; wherein: HARQ Process ID is the HPN; CURRENT_symbol=(SFN×numberOfSlotsPerFrame×numberOfSymbolsPerSlot+slot number in the frame×numberOfSymbolsPerSlot+symbol number in the slot), wherein SFN is a system frame number of a system frame associated with the UL transmission, numberOfSlotsPerFrame refers to the number of consecutive slots per frame, numberOfSymbolsPerSlot refer to the number of consecutive symbols per slot, slot number in the frame refers to a number of a slot associated with the UL transmission, and symbol number in the slot refers to a number of the first symbol of the UL transmission; periodicity is the reference parameter; nrofHARQ-Processes is the number of HARQ processes configured in the CG configuration; and harq-ProcID-Offset2 is the offset configured in the CG configuration.

In some embodiments of the present application, to determine the HPN for the DL transmission, the processor is further configured to: in the case that an offset is not configured in the SPS configuration, determine the HPN based on the following equation: HARQ Process ID=[floor (CURRENT_slot×10/(numberOfSlotsPerFrame×periodicity))] modulo nrofHARQ-Processes; and in the case that an offset is configured in the SPS configuration, determine the HPN based on the following equation: HARQ Process ID=[floor (CURRENT_slot×10/(numberOfSlotsPerFrame×periodicity))] modulo nrofHARQ-Processes+harq-ProcID-Offset; wherein: HARQ Process ID is the HPN; CURRENT_slot=[(SFN×numberOfSlotsPerFrame)+slot number in the frame], wherein SFN is a system frame number of a system frame associated with the DL transmission, numberOfSlotsPerFrame refers to the number of consecutive slots per frame, slot number in the frame refers to a number of a slot where the DL transmission starts; periodicity is the reference parameter; nrofHARQ-Processes is the number of HARQ processes configured in the SPS configuration; harq-ProcID-Offset is the offset configured in the CG configuration.

In some embodiments of the present application, the processer is further configured to obtain an HPN offset configured or preconfigured for the UE, to determine the HPN for the UL transmission or the DL transmission, the processor is further configured to: determine the HPN for the UL transmission or the DL transmission by using the HPN offset.

In some embodiments of the present application, the HPN offset is associated with an HPN periodicity, and the processor is further configured to determine the HPN for the UL transmission or the DL transmission by using the HPN offset according to the HPN periodicity.

In some embodiments of the present application, the processer is further configured to obtain a set of HPN offsets associated with a set of periodicities, to determine the HPN for the UL transmission or the DL transmission, the processor is further configured to: determine the HPN for the UL transmission or the DL transmission by using an HPN offset in the set of HPN offsets which is associated with a periodicity in which the UL transmission or the DL transmission is located.

In some embodiments of the present application, the transceiver is further configured to transmit an HPN indication for the UL transmission to a base station (BS) or receive an HPN indication for the DL transmission from the BS, the HPN indication for the UL transmission is transmitted in a time domain position configured for the UE or transmitted according to a reporting periodicity configured for the UE; or the HPN indication for the DL transmission is received in a time domain position configured for the UE or received according to an indicating periodicity configured for the UE.

In some embodiments of the present application, the processor is further configured to determine the HPN for the UL transmission based on a number of the last symbol in a periodicity including the first symbol of the UL transmission, or determine the HPN for the DL transmission based on a number of the last slot in a periodicity including a slot where the DL transmission starts.

According to some embodiments of the present application, a BS may include: a processor configured to: determine at least two periodicities with different values for a CG configuration or an SPS configuration; determine an HPN for a UL transmission corresponding to the CG configuration or a DL transmission corresponding to the SPS configuration based on a reference parameter; a transceiver coupled to the processor and configured to: receive the UL transmission based on the HPN; or transmit the DL transmission based on the HPN.

In some embodiments of the present application, the at least two periodicities with different values are in a time window, and the reference parameter is a length of the time window.

In some embodiments of the present application, the at least two periodicities with different values are in a time window, and the reference parameter is the number of periodicities included in the time window.

In some embodiments of the present application, the length of the time window is in units of symbols, and to determine the HPN for the UL transmission, the processor is further configured to perform at least one of: determining a time window including a first symbol of the UL transmission; determining a periodicity including the first symbol of the UL transmission within the time window; or determining the HPN based on the periodicity including the first symbol of the UL transmission.

In some embodiments of the present application, to determine the HPN for the UL transmission, the processor is further configured to: in the case that an offset and a retransmission timer are not configured in the CG configuration, determine the HPN for the UL transmission based on the following equation: if CURRENT_symbol−floor (CURRENT_symbol/periodicity)*periodicity is larger than or equal to a sum of values of first i periodicities within the time window and smaller than a sum of values of first i+1 periodicities within the time window, HARQ Process ID=[floor (CURRENT_symbol/periodicity)*M+i] modulo nrofHARQ-Processes; and in the case that an offset is configured in the CG configuration, determine the HPN based on the following equation: if CURRENT_symbol−floor (CURRENT_symbol/periodicity)*periodicity is larger than or equal to a sum of values of first i periodicities within the time window and smaller than a sum of values of first i+1 periodicities within the time window, HARQ Process ID=[floor (CURRENT_symbol/periodicity)*M+i] modulo nrofHARQ-Processes+harq-ProcID-Offset2; wherein: HARQ Process ID is the HPN; CURRENT_symbol=(SFN×numberOfSlotsPerFrame×numberOfSymbolsPerSlot+slot number in the frame×numberOfSymbolsPerSlot+symbol number in the slot), wherein SFN is a system frame number of a system frame associated with the UL transmission, numberOfSlotsPerFrame refers to the number of consecutive slots per frame, numberOfSymbolsPerSlot refer to the number of consecutive symbols per slot, slot number in the frame refers to a number of a slot associated with the UL transmission, and symbol number in the slot refers to a number of the first symbol of the UL transmission; periodicity is the length of the time window; M is the number of periodicities included in the time window; i is a value from 0 to M−1; nrofHARQ-Processes is the number of HARQ processes configured in the CG configuration; and harq-ProcID-Offset2 is the offset configured in the CG configuration.

In some embodiments of the present application, the length of the time window is in units of slots, and to determine the HPN for the DL transmission, the processor is further configured to perform at least one of: determining a time window including a slot where the DL transmission starts; determining a periodicity including the slot where the DL transmission starts; or determining the HPN based on the periodicity including the slot where the DL transmission starts.

In some embodiments of the present application, to determine the HPN for the DL transmission, the processor is further configured to: in the case that an offset is not configured in the SPS configuration, determine the HPN based on the following equation: if CURRENT_slot−floor (CURRENT_slot/periodicity)*periodicity is larger than or equal to a sum of values of first i periodicities within the time window and smaller than a sum of values of first i+1 periodicities within the time window, HARQ Process ID=[floor (CURRENT_slot×10/(numberOfSlotsPerFrame×periodicity))*M+i] modulo nrofHARQ-Processes; and in the case that an offset is configured in the SPS configuration, determine the HPN based on the following equation: if CURRENT_slot−floor (CURRENT_slot/periodicity)*periodicity is larger than or equal to a sum of values of first i periodicities within the time window and smaller than a sum of values of first i+1 periodicities within the time window, HARQ Process ID=[floor (CURRENT_slot×10/(numberOfSlotsPerFrame×periodicity))*M+i] modulo nrofHARQ-Processes+harq-ProcID-Offset; wherein: HARQ Process ID is the HPN; CURRENT_slot=[(SFN×numberOfSlotsPerFrame)+slot number in the frame], wherein SFN is a system frame number of a system frame associated with the DL transmission, numberOfSlotsPerFrame refers to the number of consecutive slots per frame, slot number in the frame refers to a number of a slot where the DL transmission starts; periodicity is the length of the time window; M is the number of periodicities included in the time window; i is a value from 0 to M−1; nrofHARQ-Processes is the number of HARQ processes configured in the SPS configuration; harq-ProcID-Offset is the offset configured in the CG configuration.

In some embodiments of the present application, the reference parameter is a value of one periodicity of the at least two periodicities.

In some embodiments of the present application, the one periodicity is the first periodicity in the time domain in the at least two periodicities; the transceiver is further configured to transmit RRC signaling or DCI indicating the one periodicity from the at least two periodicities; the one periodicity is a periodicity with a smallest value in the at least two periodicities; or the one periodicity is a periodicity with a largest value in the at least two periodicities.

In some embodiments of the present application, the transceiver is further configured to transmit an indication indicating a value as the reference parameter.

In some embodiments of the present application, to determine the HPN for the UL transmission, the processor is further configured to: in the case that an offset and a retransmission timer are not configured in the CG configuration, determine the HPN for the UL transmission based on the following equation: HARQ Process ID=[floor (CURRENT_symbol/periodicity)] modulo nrofHARQ-Processes; and in the case that an offset is configured in the CG configuration, determine the HPN based on the following equation: HARQ Process ID=[floor (CURRENT_symbol/periodicity)] modulo nrofHARQ-Processes+harq-ProcID-Offset2; wherein: HARQ Process ID is the HPN; CURRENT_symbol=(SFN×numberOfSlotsPerFrame×numberOfSymbolsPerSlot+slot number in the frame×numberOfSymbolsPerSlot+symbol number in the slot), wherein SFN is a system frame number of a system frame associated with the UL transmission, numberOfSlotsPerFrame refers to the number of consecutive slots per frame, numberOfSymbolsPerSlot refer to the number of consecutive symbols per slot, slot number in the frame refers to a number of a slot associated with the UL transmission, and symbol number in the slot refers to a number of the first symbol of the UL transmission; periodicity is the reference parameter; nrofHARQ-Processes is the number of HARQ processes configured in the CG configuration; and harq-ProcID-Offset2 is the offset configured in the CG configuration.

In some embodiments of the present application, to determine the HPN for the DL transmission, the processor is further configured to: in the case that an offset is not configured in the SPS configuration, determine the HPN based on the following equation: HARQ Process ID=[floor (CURRENT_slot×10/(numberOfSlotsPerFrame×periodicity))] modulo nrofHARQ-Processes; and in the case that an offset is configured in the SPS configuration, determine the HPN based on the following equation: HARQ Process ID=[floor (CURRENT_slot×10/(numberOfSlotsPerFrame×periodicity))] modulo nrofHARQ-Processes+harq-ProcID-Offset; wherein: HARQ Process ID is the HPN; CURRENT_slot=[(SFN×numberOfSlotsPerFrame)+slot number in the frame], wherein SFN is a system frame number of a system frame associated with the DL transmission, numberOfSlotsPerFrame refers to the number of consecutive slots per frame, slot number in the frame refers to a number of a slot where the DL transmission starts; periodicity is the reference parameter; nrofHARQ-Processes is the number of HARQ processes configured in the SPS configuration; harq-ProcID-Offset is the offset configured in the CG configuration.

In some embodiments of the present application, the transceiver is further configured to transmit an HPN offset to the UE or the HPN offset is preconfigured, and to determine the HPN for the UL transmission or the DL transmission, the processor is further configured to: determine the HPN for the UL transmission or the DL transmission by using the HPN offset.

In some embodiments of the present application, the HPN offset is associated with an HPN periodicity, the processor is further configured to determine the HPN for the UL transmission or the DL transmission by using the HPN offset according to the HPN periodicity.

In some embodiments of the present application, the processer is further configured to obtain a set of HPN offsets associated with a set of periodicities, to determine the HPN for the UL transmission or the DL transmission, the processor is further configured to: determine the HPN for the UL transmission or the DL transmission by using an HPN offset in the set of HPN offsets which is associated with a periodicity in which the UL transmission or the DL transmission is located.

In some embodiments of the present application, the transceiver is further configured to receive an HPN indication for the UL transmission from a UE or transmit an HPN indication for the DL transmission to the UE, the HPN indication for the UL transmission is received in a time domain position configured for the UE or transmitted according to a reporting periodicity configured for the UE; or the HPN indication for the DL transmission is transmitted in a time domain position configured for the UE or received according to an indicating periodicity configured for the UE.

In some embodiments of the present application, the processor is further configured to determine the HPN for the UL transmission based on a number of the last symbol in a periodicity including the first symbol of the UL transmission, or determine the HPN for the DL transmission based on a number of the last slot in a periodicity including a slot where the DL transmission starts.

According to some other embodiments of the present application, a method performed by a UE may include: determining at least two periodicities with different values for a CG configuration or an SPS configuration; determining an HPN for a UL transmission corresponding to the CG configuration or a DL transmission corresponding to the SPS configuration based on a reference parameter; and transmitting the UL transmission based on the HPN or receiving the DL transmission based on the HPN.

According to some other embodiments of the present application, a method performed by a BS may include: determining at least two periodicities with different values for a CG configuration or an SPS configuration; determining an HPN for a UL transmission corresponding to the CG configuration or a DL transmission corresponding to the SPS configuration based on a reference parameter; and receiving the UL transmission based on the HPN or transmitting the DL transmission based on the HPN.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present application;

FIG. 2 illustrates an exemplary method for determining PUCCH resources for HARQ information of SPS PDSCH transmissions according to some embodiments of the present application;

FIG. 3 illustrates an exemplary long periodicity within three small periodicities according to some embodiments of the present application;

FIG. 4 illustrates an exemplary method for adjusting a periodicity according to some embodiments of the present application.

FIG. 5 is a flow chart illustrating an exemplary method for determining an HPN according to some embodiments of the present application; and

FIG. 6 illustrates an exemplary method for determining an HPN for a UL transmission according to some embodiments of the present application;

FIG. 7 illustrates an exemplary method for determining an HPN for a DL transmission according to some embodiments of the present application;

FIG. 8 illustrates an exemplary method for determining an HPN for a UL transmission according to some other embodiments of the present application;

FIG. 9 illustrates an exemplary method for determining an HPN for a DL transmission according to some other embodiments of the present application;

FIG. 10 illustrates two exemplary cases for determining an HPN according to some other embodiments of the present application;

FIG. 11 illustrates an exemplary method for determining an HPN for a UL transmission according to some other embodiments of the present application;

FIG. 12 illustrates an exemplary method for determining an HPN for a DL transmission according to some other embodiments of the present application;

FIG. 13 illustrates an exemplary method for indicating an HPN for a UL transmission according to some embodiments of the present application;

FIG. 14 illustrates an exemplary method for determining an HPN for a UL transmission according to some other embodiments of the present application;

FIG. 15 is a flow chart illustrating an exemplary method for determining an HPN according to some other embodiments of the present application; and

FIG. 16 illustrates a simplified block diagram of an exemplary apparatus for determining an HPN according to some embodiments of the present application.

### DETAILED DESCRIPTION

The detailed description of the appended drawings is intended as a description of the currently preferred embodiments of the present application and is not intended to represent the only form in which the present application may be practiced. It is to be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd generation partnership project (3GPP) 5G (i.e., NR), 3GPP long term evolution (LTE) and so on. Persons skilled in the art know very well that, with the development of network architecture and new service scenarios, the embodiments in the present application are also applicable to similar technical problems; and moreover, the terminologies recited in the present application may change, which should not affect the principle of the present application.

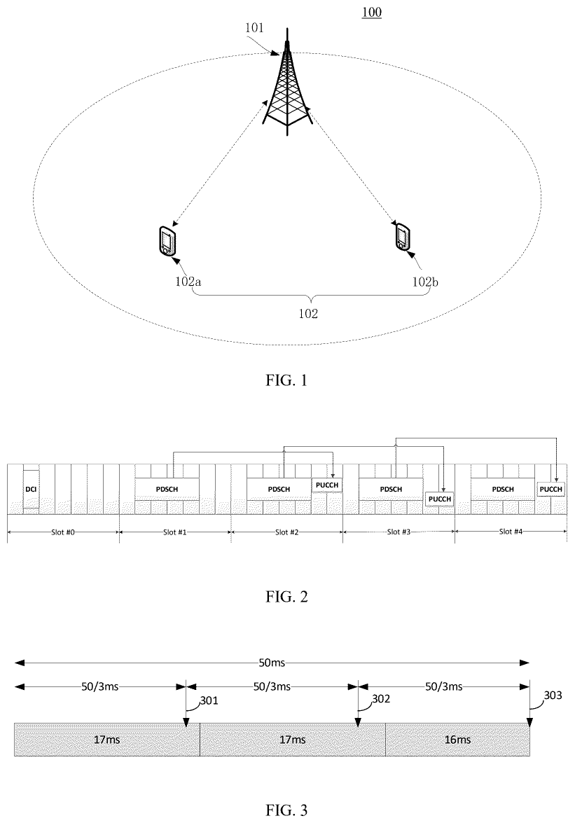

FIG. 1 is a schematic diagram illustrating an exemplary wireless communication system 100 according to some embodiments of the present application.

As shown in FIG. 1, the wireless communication system 100 includes at least one BS 101 and at least one UE 102. In particular, the wireless communication system 100 includes one BS 101 and two UEs 102 (e.g., UE 102a and UE 102b) for illustrative purposes. Although a specific number of BSs 101 and UEs 102 are depicted in FIG. 1, it is contemplated that any number of BSs 101 and UEs 102 may be included in the wireless communication system 100.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

The BS 101 may also be referred to as an access point, an access terminal, a base, a macro cell, a node-B, an enhanced node B (eNB), a generalized node B (gNB), a home node-B, a relay node, or a device, or described using other terminology used in the art. The BS 101 is generally part of a radio access network that may include a controller communicably coupled to the BS 101.

According to some other embodiments of the present application, the UE(s) 102 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present application, the UE(s) 102 may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present application, the UE(s) 102 may include wearable devices, such as smart watches, fitness bands, optical head-mounted displays, or the like.

Moreover, the UE(s) 102 may be referred to as a subscriber unit, a mobile, a mobile station, a user, a terminal, a mobile terminal, a wireless terminal, a fixed terminal, a subscriber station, a user terminal, or a device, or described using other terminology used in the art.

According to some embodiments of the present application, the UE(s) 102 may include vehicle UEs (VUEs) and/or power-saving UEs (also referred to as power sensitive UEs). The power-saving UEs may include vulnerable road users (VRUs), public safety UEs (PS-UEs), and/or commercial sidelink UEs (CS-UEs) that are sensitive to power consumption. In an embodiment of the present application, a VRU may include a pedestrian UE (P-UE), a cyclist UE, a wheelchair UE or other UEs which require power saving compared with a VUE. In an embodiment of the present application, the UE 102a may be a power-saving UE and the UE 102b may be a VUE. In another embodiment of the present application, both the UE 102a and the UE 102b may be VUEs or power-saving UEs.

Both the UE 102a and the UE 102b in the embodiments of FIG. 1 are in a coverage area of the BS 101, and may transmit information or data to the BS 101 and receive control information or data from the BS 101, for example, via an LTE or NR Uu interface. In other embodiments, one or more of the UE 102a and the UE 102b may be outside of the coverage area of the BS 101. The UE 102a and the UE 102b may communicate with each other via sidelink.

In some embodiments, a UE may be configured with one or more SPS configurations for DL transmission, e.g., physical downlink shared channel (PDSCH) transmission, wherein each of the one or more SPS configurations may include a period P. The UE may receive an activating DCI which activates an SPS configuration from the one or more SPS configurations. In addition, the activating DCI may also indicate the time domain resource and frequency domain resource of SPS PDSCH for the activated SPS configuration, and indicate a time offset value K1 (e.g., a number of slots) for determining a slot for a PUCCH transmission to transmit the HARQ information of the corresponding SPS PDSCH. In such embodiments, when it is assumed that a number of PDSCH receptions based on an activated SPS configuration ends in a slot n, then the UE may provide HARQ information for the number of PDSCH receptions in a PUCCH transmission within a slot n+K1.

FIG. 2 illustrates an exemplary method for determining PUCCH resources for HARQ information of SPS PDSCH transmissions according to some embodiments of the present application.

In the example of FIG. 2, it is assumed that there are four SPS configurations with indexes #0 to #3, respectively. A UE may receive a DCI in slot #0, which activates SPS configuration #1. The period P for SPS configuration #1 is one slot. In addition, the DCI may also indicate the time domain resource and frequency domain resource of PDSCH transmission for the activated SPS configuration #1, as shown in FIG. 2. Given this, there is one SPS PDSCH reception per slot. For simplicity, the example in FIG. 2 only illustrates three slots (e.g., slot #1, slot #2, and slot #3), wherein each slot includes an SPS PDSCH reception. In addition, when it is assumed that the DCI indicates a time offset value K1=1 slot, then HARQ information for a corresponding SPS PDSCH reception may be in a PUCCH transmission within the next slot of the corresponding SPS PDSCH reception. For example, for SPS PDSCH reception in slot #1, the HARQ information may be in a PUCCH transmission within slot #2; for SPS PDSCH reception in slot #2, the HARQ information may be in a PUCCH transmission within slot #3; for SPS PDSCH reception in slot #3, the HARQ information may be in a PUCCH transmission within slot #4.

The HARQ process number (also referred to as HARQ process identity (ID)) for SPS PDSCH may be determined based on the methods in the following examples.

In some examples, for configured downlink assignments without harq-ProcID-Offset as specified in 3GPP standard documents (e.g., harq-ProcID-Offset is not configured in an SPS configuration), the HARQ Process ID associated with the slot where the DL transmission starts is derived from the following equation:

$$HARQ Process ID = [ floor ( CURRENT\_slot \times 10 / ( numberOfSlotsPerFrame \times preiodicity ) ) ] modulo nrofHARQ - Processes .$$

Wherein CURRENT_slot=[(SFN×numberOfSlotsPerFrame)+slot number in the frame], SFN is a system frame number of a system frame associated with the DL transmission (e.g., including the slot where the DL transmission starts), numberOfSlotsPerFrame refers to the number of consecutive slots per frame as specified in TS 38.211, slot number in the frame is the slot where the DL transmission starts, periodicity is the periodicity configured in the SPS configuration, nrofHARQ-Processes is the number of HARQ processes configured in the SPS configuration.

For example, it is assumed that slot number in the frame is slot 1, numberOfSlotsPerFrame=10, nrofHARQ-Processes=8, SFN=1, and periodicity=1 slot, then CURRENT_slot=[(1×10)+1]=11, HARQ Process ID=[floor (11×10/(10×1))] modulo 8=3.

In some examples, for configured downlink assignments with harq-ProcID-Offset as specified in 3GPP standard documents (e.g., harq-ProcID-Offset is configured in an SPS configuration), the HARQ Process ID associated with the slot where the DL transmission starts is derived from the following equation:

$$HARQ Process ID = [ floor ( CURRENT\_slot \times 10 / ( numberOfSlotsPerFrame \times preiodicity ) ) ] modulo nrofHARQ - Processes + harq - ProcID - Offse t .$$

Wherein harq-ProcID-Offset is configured in the SPS configuration, and the other parameters in the above equation may have the same definitions as those in the above examples where configured downlink assignments are not configured with harq-ProcID-Offset.

For example, it is assumed that when the slot number in the frame is slot 1, numberOfSlotsPerFrame=10, nrofHARQ-Processes=8, SFN=1, periodicity=1 slot, harq-ProcID-Offset=2; then CURRENT_slot=[(1×10)+1]=11, and HARQ Process ID=[floor (11×10/(10×1))] modulo 8+2=5.

In some embodiments, a UE may be configured with one or more CG configurations for UL transmission, e.g., physical uplink shared channel (PUSCH) transmission. For each CG configuration of the one or more CG configurations, a period P (e.g., periodicity of time instants including CG resources) and a CG type may be provided. In some embodiments, a CG type may be CG type 1 or CG type 2

In CG type 1, all the transmission parameters of a CG for UL transmission are configured by a CG configuration in RRC signaling, and the CG may be activated by the RRC signaling. Accordingly, the CG type 1 PUSCH transmission may be semi-statically configured to operate upon the reception of a higher layer parameter of configuredGrantConfig including rrc-ConfiguredUplinkGrant as specified in 3GPP standard documents without the detection of an UL grant in a DCI.

In CG type 2, a UE may receive an activating DCI to activate a CG for UL transmission. A part of the transmission parameters (e.g., period P) of the CG for UL transmission are configured by a CG configuration of the one or more CG configuration, and the remaining part of the transmission parameters (e.g., time and frequency resource allocation) of the CG for UL transmission are indicated by the DCI activating the CG. Accordingly, the CG type 2 PUSCH transmission may be semi-persistently scheduled by an UL grant in activation DCI after the reception of higher layer parameter configuredGrantConfig not including rrc-ConfiguredUplinkGrant as specified in 3GPP standard documents.

The HARQ process number (also referred to as HARQ process ID) for CG PUSCH may be determined based on the methods in the following examples.

In some examples, for configured uplink grants neither configured with harq-ProcID-Offset2 nor with cg-RetransmissionTimer as specified in 3GPP standard documents (e.g., harq-ProcID-Offset2 and cg-RetransmissionTimer are not configured in a CG configuration), the HARQ Process ID associated with the first symbol of a UL transmission is derived from the following equation:

$$HARQ Process ID = [ floor ( CURRENT\_symbol / preiodicity ) ] modulo nrofHARQ - Processes .$$

Wherein CURRENT_symbol=(SFN×numberOfSlotsPerFrame×numberOfSymbolsPerSlot+slot number in the frame×numberOfSymbolsPerSlot+symbol number in the slot), SFN is a system frame number of a system frame associated with the UL transmission (e.g., a system frame including the first symbol of the UL transmission), numberOfSlotsPerFrame refers to the number of consecutive slots per frame as specified in TS 38.211, numberOfSymbolsPerSlot refer to the number of consecutive symbols per slot as specified in TS 38.211, slot number in the frame refers to a number of a slot associated with the UL transmission (e.g., a slot including the first symbol of the UL transmission), symbol number in the slot refers to a number of the first symbol of the UL transmission, periodicity is a periodicity of the CG configured in the CG configuration, nrofHARQ-Processes is the number of HARQ processes configured in the CG configuration.

For example, assuming CURRENT_symbol=10, nrofHARQ-Processes=8, and periodicity=14 symbols, then HARQ Process ID=[floor(10/14)] modulo 8=0.

In some examples, for configured uplink grants with harq-ProcID-Offset2 as specified in 3GPP standard documents (e.g., harq-ProcID-Offset2 is configured in a CG configuration), the HARQ Process ID associated with the first symbol of a UL transmission is derived from the following equation:

$$HARQ Process ID = [ floor ( CURRENT\_symbol / preiodicity ) ] modulo nrofHARQ - Processes + harq - ProcID - Offset2 .$$

Wherein harq-ProcID-Offset2 is configured in the CG configuration, and the other parameters in the above equation may have the same definitions as those in the above examples where configured uplink grants are neither configured with harq-ProcID-Offset2 nor with cg-RetransmissionTimer as specified in 3GPP standard documents.

For example, assuming CURRENT_symbol=10, nrofHARQ-Processes=8, periodicity=14 symbols, and harq-ProcID-Offset2=2, then HARQ Process ID=[floor(10/14)] modulo 8+2=2.

Based on the above equations for HPN determination for CG or SPS PDSCH, it can be determined that only one HPN may be determined for one periodicity. In addition, only one transmission (e.g., UL transmission or DL transmission) may be performed in one periodicity, and the BS and the UE may determine the HPN of the transmission according to the position of the transmission.

XR, including AR, MR, and VR, as well as CG, presents a new promising category of connected devices, applications, and services. XR applications typically require high throughput and low latency, and have big and variable data packet sizes. For XR, it was agreed that 60 frames per second (fps) is a baseline for both DL and UL video stream, and 30 fps, 90 fps as well as 120 fps may also be optionally XR frame rates. Based on the above frame rates, the periodicities corresponding to 30 fps, 60 fps, 90 fps, and 120 fps are {33.33 ms, 16.67 ms, 11.11 ms, 8.33 ms}, respectively.

However, the supported SPS periods are {10 ms, 20 ms, 32 ms, . . . , 640 ms}, {1 ms, 2 ms, . . . 640 ms} for subcarrier spacing (SCS) being 15 kHz, 0.5×{1 ms, 2 ms, . . . , 1280 ms} for SCS being 30 kHz, 0.25×{1 ms, 2 ms, . . . , 2560 ms} for SCS being 60 kHz and 0.125×{1 ms, 2 ms, . . . , 5120 ms} for SCS being 120 kHz, and the supported CG periods are {1/7 ms, 0.5 ms, 1 ms, . . . , 320 ms, 640 ms} for SCS being 15 kHz, 0.5×{1/7 ms, 0.5 ms, 1 ms, . . . , 1280 ms} for SCS being 30 kHz, 0.25×{1/7 ms, 0.5 ms, 1 ms, . . . , 2560 ms} for SCS being 60 kHz. It can be easily observed that the periodicities of XR service and periodicities of SPS or CG are not matched.

Given this, some enhancement solutions may be performed to realize the matching between the periodicities of an XR service and periodicities of SPS or CG, thereby facilitating the UL transmission or the DL transmission for XR service.

According to some embodiments of the present application, one enhancement solution (e.g., denoted as solution 1) may include using multiple small periodicities with different values to compose a long periodicity, such that the periodicities of XR service and periodicities of SPS or CG may be aligned at the boundary of the long periodicity, and each small periodicity may be used as one periodicity of the SPS or CG.

FIG. 3 illustrates an exemplary long periodicity within three small periodicities according to some embodiments of the present application.

Referring to FIG. 3, it is assumed that the periodicity of the XR service is 1000/60=50/3 ms. Then, the long periodicity may be 50 ms which includes three small periodicities, e.g., 17 ms, 17 ms, and 16 ms, which may be realized by configuring a sequence of the values of small periodicity, such as {17,17,16}, and the long periodicity could be the sum of all the values, such that the alignment between XR traffic and SPS or CG is achieved in each long periodicity. For example, within each small periodicity of the long periodicity, the transmission (e.g., DL transmission or UL transmission, which is denoted as 301-303 in FIG. 3, respectively) of the XR service may be transmitted and received once.

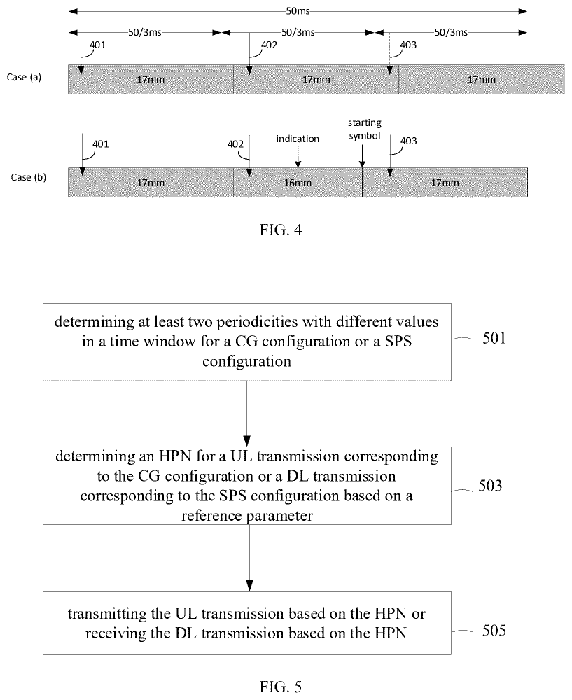

Another enhancement solution (e.g., denoted as solution 2) may include configuring a fixed periodicity and adjusting the configured periodicity per long periodicity. FIG. 4 illustrates an exemplary method for adjusting a periodicity according to some embodiments of the present application.

Referring to FIG. 4, it is assumed that the periodicity of the XR service is 1000/60=50/3 ms. The long periodicity may be 50 ms and the fixed periodicity may be configured to be 17 ms.

Referring to FIG. 4, the first small periodicity within the long periodicity may be set to be 17 ms, and a transmission (e.g., a UL transmission or a DL transmission, which is denoted as 401 in FIG. 4) may be performed in the first small periodicity. The second periodicity within the long periodicity may also be set to be 17 ms. However, referring to case (a), within the second periodicity, there would be a mismatch between the fixed periodicity and the XR service. For example, there will be two transmissions (e.g., UL transmissions or DL transmissions, which are denoted as 402 and 403 in case (a) within the second periodicity, which is not allowable for the SPS configuration or CG configuration.

In such cases, for DL SPS, the BS may transmit an indication to adjust the starting point of the third periodicity or adjust the value of the second periodicity. For UL CG, the UE may transmit an indication to adjust the starting point (e.g., starting symbol) of the third periodicity or adjust the value of the second periodicity.

Based on the above method, referring to case (b), before the third transmission (denoted as 403 in FIG. 4), the indication may be used by the UE and the BS to adjust the starting symbol of the third periodicity so as to adapt to the traffic periodicity, e.g., within each small periodicity of the long periodicity, the transmission of the XR service may be transmitted and received once.

The examples in FIG. 3 and FIG. 4 are only for illustrative purposes. Persons skilled in the art can understand the long periodicity and the small periodicity may have other values in some other embodiments.

According to the HPN determination method mentioned above, periodicity may be a parameter used to calculate the HPN of a UL transmission or a DL transmission, and for each periodicity, there is only one HPN for one data transmitted in the periodicity. However, if non-integer periodicity is supported for XR service, no matter which enhancement solution is used, the periodicities are not fixed to one value and there may be at least two periodicities with different values in a time window (e.g., in a long periodicity). Then, solutions are needed to solve the technical problem regarding how to calculate the HPN for a UL transmission or DL transmission when there are at least two periodicities configured or determined for a SPS configuration or a CG configuration.

Given the above, embodiments of the present application propose solutions for determining an HPN. The solutions of the subject application can be used for XR service and any other cases in which there are at least two periodicities configured or determined for a SPS configuration or a CG configuration. More details on embodiments of the present application will be illustrated in the following text in combination with the appended drawings.

FIG. 5 is a flow chart illustrating an exemplary method for determining an HPN according to some embodiments of the present application. The method in FIG. 5 may be implemented by a UE (e.g., UE 102a or UE 102b as shown in FIG. 1).

In the exemplary method shown in FIG. 5, in step 501, the UE may determine at least two periodicities with different values for a CG configuration or a SPS configuration.

In some examples, the UE may use solution 1 as stated above to determine at least two periodicities with different values for a CG configuration or SPS configuration. For example, the at least two periodicities may be the three small periodicities as shown in FIG. 3.

In some examples, the UE may use solution 2 as stated above to determine at least two periodicities with different values for a CG configuration or SPS configuration. For example, the at least two periodicities may be the three small periodicities as shown in FIG. 4.

In some examples, the UE may use any other method to determine at least two periodicities with different values for a CG configuration or SPS configuration, which should not affect the principle of the disclosure.

In some embodiments of the present application, the at least two periodicities with different values may be in a time window.

In some examples, the UE may use solution 1 as stated above to determine the time window. For example, the time window may be the long periodicity as shown in FIG. 3.

In some examples, the UE may use solution 2 as stated above to determine the time window. In an example, a time window may be a periodicity of the indication to indicate the adjustment of the small periodicity. For example, the time window may be the long periodicity as shown in FIG. 4.

In some examples, the UE may use any other methods to determine a time window for a CG configuration or SPS configuration, which should not affect the principle of the disclosure.

In step 503, the UE may determine an HPN (also referred to as HARQ process ID) for a UL transmission corresponding to the CG configuration or a DL transmission corresponding to the SPS configuration based on a reference parameter.

The following embodiments may provide the definitions of the reference parameter and methods for determine an HPN based on the reference parameter.

### Embodiments I

In some embodiments of the present application, the reference parameter may be a length of the time window. In some other embodiments, the reference parameter may be the number of periodicities included in the time window. In some other embodiments, the reference parameter may include the length of the time window and the number of periodicities included in the time window.

In embodiments I, HPNs may be cyclically determined among time windows. For example, it is assumed that: there are four time windows (e.g., denoted as time window #0, time window #1, time window #2, and time window #3), wherein time window #0 may include periodicities #0-#2, time window #1 may include periodicities #3-#5, time window #2 may include periodicities #6-#8, time window #3 may include periodicities #9-#11; and the number of HPNs is 8. Then, 8 HPNs may be cyclically determined among 4 time windows, where each time window may include 3 HPNs each corresponding to a periodicity in the time window. For example, the HPNs for periodicities #0-#11 may be 0, 1, 2, 3, 4, 5, 6, 7, 0, 1, 2, 3, respectively.

In such embodiments, in order to determine the HPN for the UL transmission or the DL transmission, the UE may determine the UL transmission or the DL transmission is in which time window and in which periodicity within the time window. The following descriptions illustrate how to determine the HPN for the UL transmission and the DL transmission, respectively.

In some embodiments, for the UL transmission corresponding to the CG configuration, the length of the time window is in units of symbols. In such embodiments, determining the HPN for the UL transmission may include at least one of: determining a time window including a first symbol of the UL transmission; determining a periodicity including the first symbol of the UL transmission within the time window; and determining the HPN based on the periodicity including the first symbol of the UL transmission.

For example, in the case that an offset (e.g., harq-ProcID-Offset2 as specified in 3GPP standard documents) and a retransmission timer (e.g., cg-RetransmissionTimer as specified in 3GPP standard documents) are not configured in the CG configuration (in other words, for configured uplink grants neither configured with harq-ProcID-Offset2 nor with cg-RetransmissionTimer), the UE may determine the HPN of the UL transmission (e.g., HARQ Process ID associated with the first symbol of the UL transmission) according to the following procedure.

If CURRENT_symbol−floor (CURRENT_symbol/periodicity)*periodicity is larger than or equal to a sum of values of first i periodicities within the time window and smaller than a sum of values of first i+1 periodicities within the time window,

$$HARQ Process ID = [ floor ( CURRENT\_symbol / preiodicity ) * M + i ] modulo nrofHARQ - Processes .$$

In the case that an offset (e.g., harq-ProcID-Offset2 as specified in 3GPP standard documents) is configured in the CG configuration (in other words, for configured uplink grants configured with harq-ProcID-Offset2), the UE may determine the HPN of the UL transmission (e.g., HARQ Process ID associated with the first symbol of the UL transmission) according to the following procedure.

If CURRENT_symbol−floor (CURRENT_symbol/periodicity)*periodicity is larger than or equal to a sum of values of first i periodicities within the time window and smaller than a sum of values of first i+1 periodicities within the time window,

$$HARQ Process ID = [ floor ( CURRENT\_symbol / preiodicity ) ] * M + i ] modulo nrofHARQ - Processes + harq - ProcID - Offset2 .$$

In the above cases, HARQ Process ID is the HPN; CURRENT_symbol=(SFN×numberOfSlotsPerFrame×numberOfSymbolsPerSlot+slot number in the frame×numberOfSymbolsPerSlot+symbol number in the slot), wherein SFN is a system frame number of a system frame associated with the UL transmission (e.g., a system frame including the first symbol of the UL transmission), numberOfSlotsPerFrame refers to the number of consecutive slots per frame as specified in TS 38.211, numberOfSymbolsPerSlot refer to the number of consecutive symbols per slot as specified in TS 38.211, slot number in the frame refers to a number of a slot associated with the UL transmission (e.g., a slot including the first symbol of the UL transmission), and symbol number in the slot refers to a number of the first symbol of the UL transmission; periodicity is the length of the time window; M is the number of periodicities included in the time window; i is a value from 0 to M−1; nrofHARQ-Processes is the number of HARQ processes configured in the CG configuration; and harq-ProcID-Offset2 is the offset configured in the CG configuration.

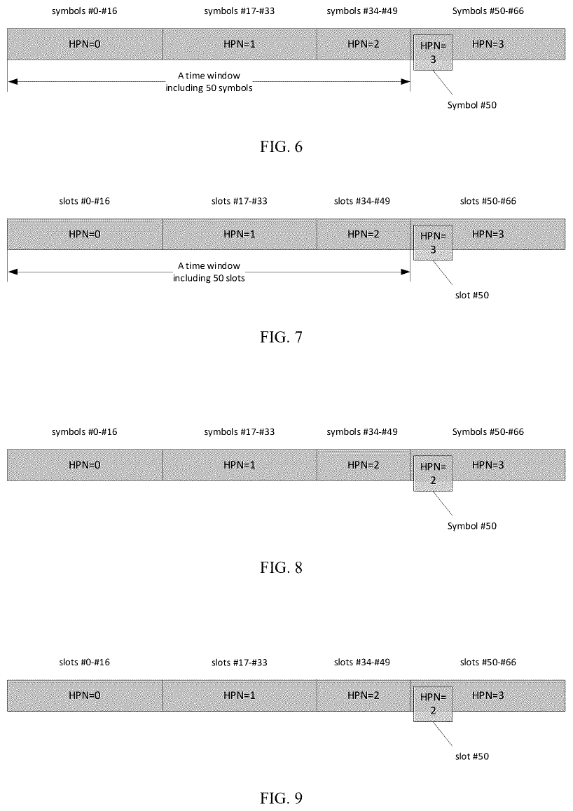

FIG. 6 illustrates an exemplary method for determining an HPN for a UL transmission according to some embodiments of the present application. In the example in FIG. 6, it is assumed that each time window includes 50 symbols and including three periodicities, wherein the three periodicities may include 17 symbols, 17 symbols, and 16 symbols, respectively.

Referring to FIG. 6, it illustrates four periodicities as an example, wherein the four periodicities include {symbol #0 to symbol #16 (also referred to as symbols 0-16)}, {symbol #17 to symbol #33 (also referred to as symbols 17-33)}, {symbol #34 to symbol #49 (also referred to as symbols 34-49)}, and {symbol #50 to symbol #66 (also referred to as symbols 50-66)}, respectively. The first three periodicities may be included in a time window, and the fourth periodicity may be included in another time window.

It is assumed that SFN=0, numberOfSlotsPerFrame=10, numberOfSymbolsPerSlot=14, and the slot number in the frame=3, and symbol number in the slot=8, then the CURRENT_symbol=(SFN×numberOfSlotsPerFrame×numberOfSymbolsPerSlot+slot number in the frame×numberOfSymbolsPerSlot+symbol number in the slot)=(0×10×14+3×14+8)=50. That is, the first symbol of the UL transmission is symbol #50 in FIG. 6.

It is also assumed that an offset and a retransmission timer are not configured in the CG configuration and nrofHARQ-Processes=8. Then, the HPN for the UL transmission may be determined based on the following procedure.

CURRENT_symbol=50, and thus CURRENT_symbol−floor (CURRENT_symbol/periodicity)*periodicity=50−floor(50/50)*50=0. Since 0 is larger than or equal to a sum of values of first 0 periodicities (e.g., 0 symbol) within the time window and smaller than a sum of value of first 1 periodicity (e.g., 17 symbols) within the time window, i=0.

Then, the UE may determine that the HARQ Process ID=[floor (CURRENT_symbol/periodicity)*M+i] modulo nrofHARQ-Processes=[floor(50/50)*3+0] modulo 8=3. That is, the HPN for the UL transmission is 3.

Based on the same methods, the UE may also determine that the HPN for the UL transmission is 0 when CURRENT_symbol=0-16, the HPN for the UL transmission is 1 when CURRENT_symbol=17-33, the HPN for the UL transmission is 2 when CURRENT_symbol=34-49, and the HPN for the UL transmission is 3 when CURRENT_symbol=50-66.

In some embodiments, for the DL transmission corresponding to the SPS configuration, the length of the time window is in units of slots. In such embodiments, determining the HPN for the UL transmission may include at least one of: determining a time window including a slot where the DL transmission starts; determining a periodicity including the slot where the DL transmission starts; and determining the HPN based on the periodicity including the slot where the DL transmission starts.

For example, in the case that an offset (e.g., harq-ProcID-Offset as specified in 3GPP standard documents) is not configured in the SPS configuration (in other words, for configured downlink assignments without harq-ProcID-Offset), the UE may determine the HPN of the DL transmission (e.g., the HARQ Process ID associated with a slot where the DL transmission starts) according to the following procedure.

If CURRENT_slot−floor (CURRENT_slot/periodicity)*periodicity is larger than or equal to a sum of values of first i periodicities within the time window and smaller than a sum of values of first i+1 periodicities within the time window,

$$HARQ Process ID = [ \text{} floor ( CURRENT\_slot \times 10 / ( numberOfSlotsPerFrame \times periodicity ) ) * M + i ] modulo nrofHARQ - Processes .$$

In the case that an offset (e.g., harq-ProcID-Offset as specified in 3GPP standard documents) is configured in the SPS configuration (in other words, for configured downlink assignments with harq-ProcID-Offset), the UE may determine the HPN of the DL transmission (e.g., the HARQ Process ID associated with a slot where the DL transmission starts) according to the following procedure.

If CURRENT_slot−floor (CURRENT_slot/periodicity)*periodicity is larger than or equal to a sum of values of first i periodicities within the time window and smaller than a sum of values of first i+1 periodicities within the time window,

$$HARQ Process ID = [ \text{} floor ( CURRENT\_slot \times 10 / ( numberOfSlotsPerFrame \times periodicity ) ) * M + i ] modulo nrofHARQ - Processes + harq - ProcID - Offset .$$

In the above cases, HARQ Process ID is the HPN; CURRENT_slot=[(SFN×numberOfSlotsPerFrame)+slot number in the frame], wherein SFN is a system frame number of a system frame associated with the DL transmission, numberOfSlotsPerFrame refers to the number of consecutive slots per frame as specified in TS 38.211, slot number in the frame refers to a number of a slot where the DL transmission starts; periodicity is the length of the time window; M is the number of periodicities included in the time window; i is a value from 0 to M−1; nrofHARQ-Processes is the number of HARQ processes configured in the SPS configuration; harq-ProcID-Offset is the offset configured in the SPS configuration.

FIG. 7 illustrates an exemplary method for determining an HPN for a DL transmission according to some embodiments of the present application. In the example in FIG. 7, it is assumed that each time window includes 50 slots and including three periodicities, wherein the three periodicities may include 17 slots, 17 slots, and 16 slots, respectively.

Referring to FIG. 7, it illustrates four periodicities as an example, wherein the four periodicities include {slot #0 to slot #16 (also referred to as slots 0-16)}, {slot #17 to slot #33 (also referred to as slots 17-33)}, {slot #34 to slot #49 (also referred to as slots 34-49)}, and {slot #50 to slot #66 (also referred to as slots 50-66)}, respectively. The first three periodicities may be included in a time window, and the fourth periodicity may be included in another time window.

It is assumed that SFN=5, numberOfSlotsPerFrame=10, and the slot number in the frame=0, then the CURRENT_slot=[(SFN×numberOfSlotsPerFrame)+slot number in the frame]=[(5×10)+0]=50. That is, the slot where the DL transmission starts is slot #50 in FIG. 6.

It is also assumed that an offset is not configured in the SPS configuration and nrofHARQ-Processes=8. Then, the HPN for the DL transmission may be determined based on the following procedure.

CURRENT_slot=50, and thus CURRENT_slot−floor (CURRENT_slot/periodicity)*periodicity=50−floor(50/50)*50=0. Since 0 is larger than or equal to a sum of values of first 0 periodicities (e.g., 0 slot) within the time window and smaller than a sum of value of first 1 periodicity (e.g., 17 slots) within the time window, i=0.

Then, the UE may determine that HARQ Process ID=[floor (CURRENT_slot×10/(numberOfSlotsPerFrame×periodicity))*M+i] modulo nrofHARQ-Processes=[floor (50×10/(10×50))*3+0] modulo 8=3. That is, the HPN for the DL transmission is 3.

Based on the same methods, the UE may also determine that the HPN for the DL transmission is 0 when CURRENT_slot=0-16, the HPN for the DL transmission is 1 when CURRENT_slot=17-33, the HPN for the DL transmission is 2 when CURRENT_slot=34-49, and the HPN for the DL transmission is 3 when CURRENT_slot=50-66.

### Embodiments II

In embodiments II, the reference parameter may be a value of one periodicity of the at least two periodicities.

In some embodiments, the one periodicity may be the first periodicity in the time domain in the at least two periodicities. For example, it is assumed that the at least two periodicities include three periodicities. The three periodicities may be denoted as periodicity #0, periodicity #1, and periodicity #2 in an ascending order of times in the time domain. That is, periodicity #0 is the first periodicity in the time domain in the at least two periodicities. Assuming that the values of periodicity #0, periodicity #1, periodicity #2 are 17 slots, 17 slots, and 16 slots, respectively, and thus the reference parameter may be determined as the value of periodicity #0, i.e., 17 slots.

In some other embodiments, the UE may receive RRC signaling or DCI (e.g., including an indication) indicating the one periodicity from the at least two periodicities. For example, it is assumed that the at least two periodicities include three periodicities and the values of the three periodicities are 17 slots, 17 slots, and 16 slots, respectively. The RRC signaling or DCI may indicate 17 slots, and thus the reference parameter may be determined as 17 slots.

In some other embodiments, the one periodicity is a periodicity with a smallest value in the at least two periodicities. For example, it is assumed that the at least two periodicities include three periodicities and the values of the three periodicities are 17 slots, 17 slots, and 16 slots, respectively. The one periodicity with a smallest value may be the periodicity with 16 slots, and thus the reference parameter may be determined as 16 slots.

In some other embodiments, the one periodicity is a periodicity with a largest value in the at least two periodicities. For example, it is assumed that the at least two periodicities include three periodicities and the values of the three periodicities are 17 slots, 17 slots, and 16 slots, respectively. The one periodicity with a largest value may be any periodicity with 17 slots, and thus the reference parameter may be determined as 17 slots.

### Embodiments III

In embodiments III, the UE may receive an indication indicating a value as the reference parameter from the BS. For example, for the UL transmission, the value indicated by the BS may be in units of symbols. For the DL transmission, the value indicated by the indication may be in units of slots. The value indicated by the BS may be the same as the value of one periodicity of the at least two periodicities or may be different from values of all periodicities of the at least two periodicities.

In some embodiments, the value indicated by the BS may have relationship with at least one periodicity of the at least two periodicities. For example, the value may be a value of one periodicity in the at least two periodicities plus an offset.

The following embodiments provide methods regarding how to use the reference parameter determined in embodiments II or embodiments III to determine the HPN for the UL transmission or for the DL transmission.

### Embodiments 1

In embodiments 1, for the UL transmission corresponding to the CG configuration, the HPN may be determined as follows.

In the case that an offset (e.g., harq-ProcID-Offset2 as specified in 3GPP standard documents) and a retransmission timer (e.g., cg-RetransmissionTimer as specified in 3GPP standard documents) are not configured in the CG configuration (in other words, for configured uplink grants neither configured with harq-ProcID-Offset2 nor with cg-RetransmissionTimer), the UE may determine the HPN of the UL transmission (e.g., HARQ Process ID associated with the first symbol of the UL transmission) based on the following equation.

$$HARQ Process ID = [ \text{} floor ( CURRENT\_symbol / periodicity ) ] \text{} modulo nrofHARQ - Processes .$$

In the case that an offset (e.g., harq-ProcID-Offset2 as specified in 3GPP standard documents) is configured in the CG configuration (in other words, for configured uplink grants configured with harq-ProcID-Offset2), the UE may determine the HPN of the UL transmission (e.g., HARQ Process ID associated with the first symbol of the UL transmission) according to the following equation.

$$HARQ Process ID = [ \text{} floor ( CURRENT\_symbol / periodicity ) ] \text{} modulo nrofHARQ - Processes + harq - ProcID - Offset 2.$$

In the above cases, HARQ Process ID is the HPN; CURRENT_symbol=(SFN×numberOfSlotsPerFrame×numberOfSymbolsPerSlot+slot number in the frame×numberOfSymbolsPerSlot+symbol number in the slot), wherein SFN is a system frame number of a system frame associated with the UL transmission, numberOfSlotsPerFrame refers to the number of consecutive slots per frame, numberOfSymbolsPerSlot refer to the number of consecutive symbols per slot, slot number in the frame refers to a number of a slot associated with the UL transmission, and symbol number in the slot refers to a number of the first symbol of the UL transmission; periodicity is the reference parameter which is determined based on the methods in embodiments II or embodiments III; nrofHARQ-Processes is the number of HARQ processes configured in the CG configuration; and harq-ProcID-Offset2 is the offset configured in the CG configuration.

FIG. 8 illustrates an exemplary method for determining an HPN for a UL transmission according to some other embodiments of the present application. In the example in FIG. 8, the assumptions in FIG. 6 may apply. The difference are that the four periodicities may be or may be not in time window(s), and the reference parameter in FIG. 8 is 17 symbols determined based on the methods in embodiments II or embodiments III.

It is assumed that CURRENT_symbol=50, and an offset and a retransmission timer are not configured in the CG configuration, then HARQ Process ID=[floor (CURRENT_symbol/periodicity)] modulo nrofHARQ-Processes=[floor(50/17)] modulo 8=2.

### Embodiments 2

In embodiments 2 for the DL transmission corresponding to the SPS configuration, the HPN may be determined as follows.

In the case that an offset (e.g., harq-ProcID-Offset as specified in 3GPP standard documents) is not configured in the SPS configuration (in other words, for configured downlink assignments without harq-ProcID-Offset), the UE may determine the HPN of the DL transmission (e.g., the HARQ Process ID associated with a slot where the DL transmission starts) according to the following equation.

$$HARQ Process ID = [ \text{} floor ( CURRENT\_slot \times 10 / ( numberOfSlotsPerFrame \times periodicity ) ) ] * modulo nrofHARQ - Processes .$$

In the case that an offset (e.g., harq-ProcID-Offset as specified in 3GPP standard documents) is configured in the SPS configuration (in other words, for configured downlink assignments with harq-ProcID-Offset), the UE may determine the HPN of the DL transmission (e.g., the HARQ Process ID associated with a slot where the DL transmission starts) according to the following equation.

$$HARQ Process ID = [ \text{} floor ( CURRENT\_slot \times 10 / ( numberOfSlotsPerFrame \times periodicity ) ) ] modulo nrofHARQ - Processes + harq - ProcID - Offset .$$

In the above cases, HARQ Process ID is the HPN; CURRENT_slot=[(SFN×numberOfSlotsPerFrame)+slot number in the frame], wherein SFN is a system frame number of a system frame associated with the DL transmission, numberOfSlotsPerFrame refers to the number of consecutive slots per frame, slot number in the frame refers to a number of a slot where the DL transmission starts; periodicity is the reference parameter which is determined based on the methods in embodiments II or embodiments III; nrofHARQ-Processes is the number of HARQ processes configured in the SPS configuration; harq-ProcID-Offset is the offset configured in the CG configuration.

FIG. 9 illustrates an exemplary method for determining an HPN for a DL transmission according to some other embodiments of the present application. In the example in FIG. 9, the assumptions in FIG. 7 may apply. The difference is that the four periodicities may be or may be not in time window(s), and the reference parameter in FIG. 9 is 17 slots determined based on the methods in embodiments II or embodiments III.

It is assumed that CURRENT_slot=50, and an offset is not configured in the SPS configuration, then HARQ Process ID=[floor (CURRENT_slot×10/(numberOfSlotsPerFrame×periodicity))] modulo nrofHARQ-Processes=[floor (50×10/(10×17))] modulo 8=2.

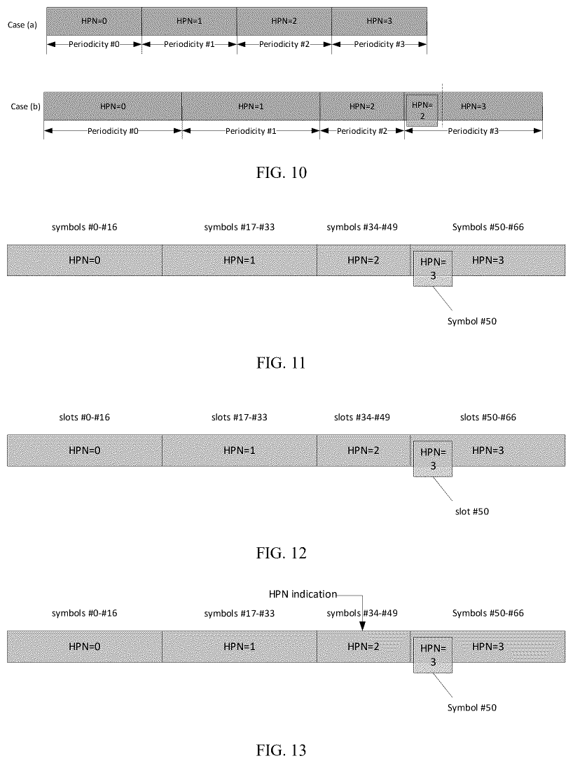

In some cases, using the reference parameter determined based on the methods in embodiments II or embodiments III to determine the HPN for UL transmission or DL transmission may bring some issues, which may be illustrated in FIG. 10.

Specifically, FIG. 10 illustrates two exemplary cases for determining an HPN according to some other embodiments of the present application. In FIG. 10, it illustrates 4 periodicities (denoted as periodicities #0-#3) as an example.

In case (a) of FIG. 10, the four periodicities may have the same value. According to the HPN determination method mentioned before, for each periodicity, there is only one HPN for one data transmitted in the periodicity. For example, as shown in case (a) of FIG. 10, for periodicity #0, HPN=0 for periodicity #1, HPN=1 for periodicity #2, HPN=2 for periodicity #3, HPN=3

In case (b) of FIG. 10, the four periodicities may have different values. For example, it is assumed that the values of the four periodicities are 17 symbols, 17 symbols, 16 symbols, and 17 symbols. If 17 symbols is used as the reference parameter to determine the HPN, based on the above embodiments 1 and 2, it can be determined that for the UL transmission in the first few symbols of periodicity #3, the HPN is still 2, but for the data transmission in the last few symbols of forth periodicity, the HPN is 3. As a result, there would be two HPNs in periodicity #3. However, if HPN=2 is used in periodicity #2, the data in the first few symbols of periodicity #3 may not be transmitted considering the out of order condition, which may increase the transmission latency of the data in periodicity #3.

The following embodiments may provide several methods to solve the above problem.

According to some embodiments of the present application, the UE may obtain an HPN offset. In some cases, the HPN offset may be configured to the UE by the BS (i.e., the UE receives the HPN offset from the BS). In some other cases, the HPN offset may be preconfigured to the UE (e.g., fixed in the 3GPP standard documents). In such embodiments, determining the HPN for the UL transmission or the DL transmission may include determining the HPN for the UL transmission or the DL transmission by using the HPN offset. The methods for using the HPN offset to determine the HPN may refer to the following embodiments.

### Embodiments 3

In embodiments 3, for the UL transmission, the equation in embodiments 1 may change as follows.

In the case that an offset (e.g., harq-ProcID-Offset2 as specified in 3GPP standard documents) and a retransmission timer (e.g., cg-RetransmissionTimer as specified in 3GPP standard documents) are not configured in the CG configuration (in other words, for configured uplink grants neither configured with harq-ProcID-Offset2 nor with cg-RetransmissionTimer), the UE may determine the HPN of the UL transmission (e.g., HARQ Process ID associated with the first symbol of the UL transmission) based on the following equation.

$$HARQ Process ID = [ \text{} floor ( CURRENT\_symbol / periodicity ) ] \text{} modulo nrofHARQ - Processes + HPN offset .$$

In the case that an offset (e.g., harq-ProcID-Offset2 as specified in 3GPP standard documents) is configured in the CG configuration (in other words, for configured uplink grants configured with harq-ProcID-Offset2), the UE may determine the HPN of the UL transmission (e.g., HARQ Process ID associated with the first symbol of the UL transmission) according to the following equation.

$$HARQ Process ID = [ \text{} floor ( CURRENT\_symbol / periodicity ) ] \text{} modulo nrofHARQ - Processes + harq - ProcID - Offset 2 + HPN offset .$$

In the above cases, HPN offset is configured or pre-configured to the UE as stated above, the other parameters may have the same definitions as in embodiments 1.

### Embodiments 4

In embodiments 4, for the DL transmission, the equation in embodiments 2 may change as follows.

In the case that an offset (e.g., harq-ProcID-Offset as specified in 3GPP standard documents) is not configured in the SPS configuration (in other words, for configured downlink assignments without harq-ProcID-Offset), the UE may determine the HPN of the DL transmission (e.g., the HARQ Process ID associated with a slot where the DL transmission starts) according to the following equation.

$$HARQ Process ID = [ \text{} floor ( CURRENT\_slot \times 10 / ( numberOfSlotsPerFrame \times periodicity ) ) ] \text{} modulo nrofHARQ - Processes + HPN offset .$$

In the case that an offset (e.g., harq-ProcID-Offset as specified in 3GPP standard documents) is configured in the SPS configuration (in other words, for configured downlink assignments with harq-ProcID-Offset), the UE may determine the HPN of the DL transmission (e.g., the HARQ Process ID associated with a slot where the DL transmission starts) according to the following equation.

$$HARQ Process ID = [ \text{} floor ( CURRENT\_slot \times 10 / ( numberOfSlotsPerFrame \times periodicity ) ) ] modulo nrofHARQ - Processes + harq - ProcID - Offset + HPN offset .$$

In the above cases, HPN offset is configured or pre-configured to the UE as stated above, the other parameters may have the same definitions as in embodiments 1.

In some embodiments of the present application, the HPN offset configured or pre-configured to the UE may be associated with an HPN periodicity. In such embodiments, determining the HPN for the UL transmission or the DL transmission may include determine the HPN for the UL transmission or the DL transmission by using the HPN offset according to the HPN periodicity. For example, the UE may use the HPN offset (e.g., using the HPN offset as shown in the equations in embodiments 3 and 4) once every HPN periodicity to determine HPN. In other times, the UE may use the equations in embodiments 1 and 2 to determine HPN.

The HPN periodicity may include one or more time units. A time unit may be a slot, a symbol, a sub-slot, 1 ms, 1 s, etc.

For example, for the UL transmission, the HPN periodicity may be in units of symbols. Assuming that the HPN periodicity is 20 symbols, and the UE first uses the HPN offset (e.g., using the HPN offset as shown as shown in the equations in embodiments 3) at symbol #10, then the UE may use the HPN offset in symbol #30, symbol #50, etc.

In another example, for the DL transmission, the HPN periodicity may be in units of slots. Assuming that the HPN periodicity is 20 slots, and the UE first uses the HPN offset (e.g., using the HPN offset as shown in the equations in embodiments 4) at slot #10, then the UE may use the HPN offset in slot #30, slot #50, etc.

According to some other embodiments of the present application, the UE may obtain a set of HPN offsets associated with a set of periodicities, wherein each periodicity of the set of periodicities is associated with an HPN offset in the set of HPN offsets. In such embodiments, determining the HPN for the UL transmission or the DL transmission may include determining the HPN for the UL transmission or the DL transmission by using an HPN offset in the set of HPN offsets which is associated with a periodicity in which the UL transmission or the DL transmission is located. The methods for using the HPN offset to determine the HPN may refer to the following embodiments.

### Embodiments 5

In embodiments 5, for the UL transmission, the equation in embodiments 1 may change as follows.

In the case that an offset (e.g., harq-ProcID-Offset2 as specified in 3GPP standard documents) and a retransmission timer (e.g., cg-RetransmissionTimer as specified in 3GPP standard documents) are not configured in the CG configuration (in other words, for configured uplink grants neither configured with harq-ProcID-Offset2 nor with cg-RetransmissionTimer), the UE may determine the HPN of the UL transmission (e.g., HARQ Process ID associated with the first symbol of the UL transmission) based on the following equation.

$$HARQ Process ID = [ \text{} floor ( CURRENT\_symbol / periodicity ) ] \text{} modulo nrofHARQ - Processes + HPN offset .$$

In the case that an offset (e.g., harq-ProcID-Offset2 as specified in 3GPP standard documents) is configured in the CG configuration (in other words, for configured uplink grants configured with harq-ProcID-Offset2), the UE may determine the HPN of the UL transmission (e.g., HARQ Process ID associated with the first symbol of the UL transmission) according to the following equation.

$$HARQ Process ID = [ \text{} floor ( CURRENT\_symbol / periodicity ) ] \text{} modulo nrofHARQ - Processes + harq - ProcID - Offset 2 + HPN offset .$$

In the above cases, HPN offset is an HPN offset in the set of HPN offsets which is associated with a periodicity in which the UL transmission is located, the other parameters may have the same definitions as in embodiments 1.

FIG. 11 illustrates an exemplary method for determining an HPN for a UL transmission according to some other embodiments of the present application. In the example in FIG. 11, all the assumptions in FIG. 8 may apply. In addition, it is assumed that a set of HPN offsets associated with four periodicities in FIG. 11 is {0,0,0,1}, wherein periodicity #0 is associated with HPN offset being “0,” periodicity #1 is associated with HPN offset being “0,” periodicity #2 is associated with HPN offset being “0,” and periodicity #3 is associated with HPN offset being “1.”

Then, for a UL transmission with the first symbol at symbol 50 (e.g., CURRENT_symbol=50), HARQ Process ID=[floor (CURRENT_symbol/periodicity)] modulo nrofHARQ-Processes+HPN offset=[floor (50/17)] modulo 8+1=3.

### Embodiments 6

In embodiments 6, for the DL transmission, the equation in embodiments 2 may change as follows.

In the case that an offset (e.g., harq-ProcID-Offset as specified in 3GPP standard documents) is not configured in the SPS configuration (in other words, for configured downlink assignments without harq-ProcID-Offset), the UE may determine the HPN of the DL transmission (e.g., the HARQ Process ID associated with a slot where the DL transmission starts) according to the following equation.

$$HARQ Process ID = [ \text{} floor ( CURRENT\_slot \times 10 / ( numberOfSlotsPerFrame \times periodicity ) ) ] \text{} modulo nrofHARQ - Processes + HPN offset .$$

In the case that an offset (e.g., harq-ProcID-Offset as specified in 3GPP standard documents) is configured in the SPS configuration (in other words, for configured downlink assignments with harq-ProcID-Offset), the UE may determine the HPN of the DL transmission (e.g., the HARQ Process ID associated with a slot where the DL transmission starts) according to the following equation.

$$HARQ Process ID = [ \text{} floor ( CURRENT\_slot \times 10 / ( numberOfSlotsPerFrame \times periodicity ) ) ] modulo nrofHARQ - Processes + harq - ProcID - Offset + HPN offset .$$

In the above cases, HPN offset is an HPN offset in the set of HPN offsets which is associated with a periodicity in which the DL transmission is located, the other parameters may have the same definitions as in embodiments 2.

FIG. 12 illustrates an exemplary method for determining an HPN for a DL transmission according to some other embodiments of the present application. In the example in FIG. 12, all the assumptions in FIG. 9 may apply. In addition, it is assumed that a set of HPN offsets associated with four periodicities in FIG. 12 is {0,0,0,1}, wherein periodicity #0 is associated with HPN offset being “0,” periodicity #1 is associated with HPN offset being “0,” periodicity #2 is associated with HPN offset being “0,” and periodicity #3 is associated with HPN offset being “1.”

Then, for a slot where the DL transmission starts is slot 50 (e.g., CURRENT_slot=50), HARQ Process ID=[floor (CURRENT_slot×10/(numberOfSlotsPerFrame×periodicity))] modulo nrofHARQ-Processes+HPN offset=HARQ Process ID=[floor (50×10/(10×17))] modulo 8+1=3.

According to some other embodiments of the present application, the UE may transmit an HPN indication for the UL transmission to the BS. The HPN indication may indicate an HPN determined by the UE. For example, HPN determined by the UE may be different from an HPN determined based on a method (e.g., the method in Embodiments 1) used by both the BS and the UE. For example, the UE may determine a first HPN for the UL transmission based on the methods in embodiments 1. However, the UE may also determine that the first HPN is not correct and determine a correct HPN for the UL transmission. In such embodiments, the UE may transmit an HPN indication for the UL transmission to the BS, the HPN indication may indicate the correct HPN.

In some embodiments, the HPN indication for the UL transmission may be included in CG uplink control information (CG-UCI). In some embodiments, the HPN indication for the UL transmission may be transmitted in a time domain position configured for the UE or transmitted according to a reporting periodicity configured for the UE.

FIG. 13 illustrates an exemplary method for indicating HPN for a UL transmission according to some embodiments of the present application. In the example in FIG. 13, all the assumptions in FIG. 8 may apply. Then, for a UL transmission with the first symbol at symbol 50 (e.g., CURRENT_symbol=50), the UE and the BS may both determine HARQ Process ID=[floor (CURRENT_symbol/periodicity)] modulo nrofHARQ-Processes=[floor(50/17)] modulo 8=2.

However, the UE knows that HPN=2 is not correct and the HPN should be 3. Then, the UE may transmit, before the UL transmission, an HPN indication indicating HPN=3 for the UL transmission to the BS, such that the UE and the BS may use the correct HPN.

According to some other embodiments of the present application, the UE may receive an HPN indication for the DL transmission from the BS before the DL transmission. The HPN indication may indicate an HPN determined by the BS. For example, HPN determined by the BS may be different from an HPN determined based on a method (e.g., the method in Embodiments 2) used by both the BS and the UE.

In some embodiments, the HPN indication for the DL transmission may be received in a time domain position configured for the UE or received according to an indicating periodicity configured for the UE.

According to some embodiments of the present application, the UE may determine the HPN for the UL transmission based on a number of the last symbol in a periodicity including the first symbol of the UL transmission or determine the HPN for the DL transmission based on a number of the last slot in a periodicity including a slot where the DL transmission starts. The examples for using the last symbol to determine the HPN for the UL transmission or using the last slot to determine the HPN for the DL transmission may be as follows.

For example, for the UL transmission corresponding to the CG configuration, the UE may still use the equations in embodiments 1 to determine the HPN. However, the definition of the CURRENT_symbol may change. For example, the CURRENT_symbol may equal a number of the last symbol in a periodicity including the first symbol of the UL transmission.

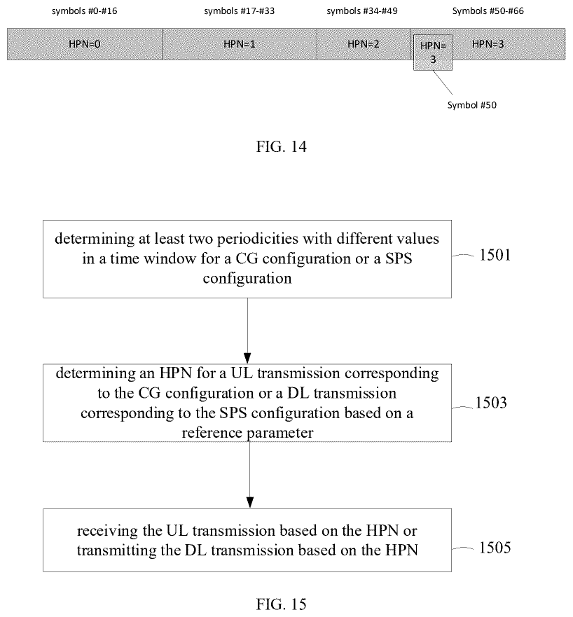

FIG. 14 illustrates an exemplary method for determining an HPN for a UL transmission according to some other embodiments of the present application. In the example in FIG. 11, all the assumptions in FIG. 8 may apply.

Then, for a UL transmission with the first symbol at symbol 50, CURRENT_symbol may be a number of the last symbol in periodicity #3, i.e., symbol 66. Accordingly, the UE may determine HARQ Process ID=[floor (CURRENT_symbol/periodicity)] modulo nrofHARQ-Processes=[floor (66/17)] modulo 8=3.

In another example, for the DL transmission corresponding to the SPS configuration, the UE may still use the equations in embodiments 2 to determine the HPN. However, the definition of the CURRENT_slot may change. For example, the CURRENT_slot may equal a number of the last slot in a periodicity including a slot where the DL transmission starts.

After determining the HPN for the UL transmission, in step 505, the UE may transmit the UL transmission based on the HPN to the BS. Alternatively, after determining the HPN for the DL transmission, in step 505, the UE may receive the DL transmission based on the HPN from the BS.

FIG. 15 is a flow chart illustrating an exemplary method for determining an HPN according to some other embodiments of the present application. The method in FIG. 15 may be implemented by a BS (e.g., BS 101 as shown in FIG. 1).

In the exemplary method shown in FIG. 15, in step 1501, the BS may determine at least two periodicities with different values for a CG configuration or a SPS configuration. All the methods for determining at least two periodicities with different values for a CG configuration or a SPS configuration performed by a UE in FIG. 5 may apply here.

In some embodiments of the present application, the at least two periodicities with different values are in a time window. All the methods for determining the time window for a CG configuration or a SPS configuration performed by a UE in FIG. 5 may apply here.

In step 1503, the BS may determine an HPN (also referred to as HARQ process ID) for a UL transmission corresponding to the CG configuration or a DL transmission corresponding to the SPS configuration based on a reference parameter. All the methods for determining the HPN performed by a UE in FIG. 5 may apply here.

### Embodiments I

In some embodiments, the reference parameter may be a length of the time window. In some other embodiments, the reference parameter may be the number of periodicities included in the time window. In some other embodiments, the reference parameter may include the length of the time window and the number of periodicities included in the time window.

In such embodiments, for the UL transmission corresponding to the CG configuration, the length of the time window is in units of symbols. In such embodiments, determining the HPN for the UL transmission may include at least one of: determining a time window including a first symbol of the UL transmission; determining a periodicity including the first symbol of the UL transmission within the time window; and determining the HPN based on the periodicity including the first symbol of the UL transmission.

For example, in the case that an offset (e.g., harq-ProcID-Offset2 as specified in 3GPP standard documents) and a retransmission timer (e.g., cg-RetransmissionTimer as specified in 3GPP standard documents) are not configured in the CG configuration (in other words, for configured uplink grants neither configured with harq-ProcID-Offset2 nor with cg-RetransmissionTimer), the BS may determine the HPN of the UL transmission (e.g., HARQ Process ID associated with the first symbol of the UL transmission) according to the following procedure.

If CURRENT_symbol−floor (CURRENT_symbol/periodicity)*periodicity is larger than or equal to a sum of values of first i periodicities within the time window and smaller than a sum of values of first i+1 periodicities within the time window,

$$HARQ Process ID = [ \text{} floor ( CURRENT\_symbol / periodicity ) ] * M + i ] modulo nrofHARQ - Processes .$$

In the case that an offset (e.g., harq-ProcID-Offset2 as specified in 3GPP standard documents) is configured in the CG configuration (in other words, for configured uplink grants configured with harq-ProcID-Offset2), the BS may determine the HPN of the UL transmission (e.g., HARQ Process ID associated with the first symbol of the UL transmission) according to the following procedure.

If CURRENT_symbol−floor (CURRENT_symbol/periodicity)*periodicity is larger than or equal to a sum of values of first i periodicities within the time window and smaller than a sum of values of first i+1 periodicities within the time window,

$$HARQ Process ID = [ floor ( CURRENT\_symbol / periodicity ) * M + i ] modulo nrofHARQ - Processes + harq - ProcID - Offset 2 .$$

In the above cases, HARQ Process ID is the HPN; CURRENT_symbol=(SFN×numberOfSlotsPerFrame×numberOfSymbolsPerSlot+slot number in the frame×numberOfSymbolsPerSlot+symbol number in the slot), wherein SFN is a system frame number of a system frame associated with the UL transmission (e.g., a system frame including the first symbol of the UL transmission), numberOfSlotsPerFrame refers to the number of consecutive slots per frame as specified in TS 38.211, numberOfSymbolsPerSlot refer to the number of consecutive symbols per slot as specified in TS 38.211, slot number in the frame refers to a number of a slot associated with the UL transmission (e.g., a slot including the first symbol of the UL transmission), and symbol number in the slot refers to a number of the first symbol of the UL transmission; periodicity is the length of the time window; M is the number of periodicities included in the time window; i is a value from 0 to M−1; nrofHARQ-Processes is the number of HARQ processes configured in the CG configuration; and harq-ProcID-Offset2 is the offset configured in the CG configuration.

In such embodiments, for the DL transmission corresponding to the SPS configuration, the length of the time window is in units of slots. In such embodiments, determining the HPN for the UL transmission may include at least one of: determining a time window including a slot where the DL transmission starts; determining a periodicity including the slot where the DL transmission starts; and determining the HPN based on the periodicity including the slot where the DL transmission starts.

For example, in the case that an offset (e.g., harq-ProcID-Offset as specified in 3GPP standard documents) is not configured in the SPS configuration (in other words, for configured downlink assignments without harq-ProcID-Offset), the BS may determine the HPN of the DL transmission (e.g., the HARQ Process ID associated with a slot where the DL transmission starts) according to the following procedure.

If CURRENT_slot−floor (CURRENT_slot/periodicity)*periodicity is larger than or equal to a sum of values of first i periodicities within the time window and smaller than a sum of values of first i+1 periodicities within the time window,

$$HARQ Process ID = [ \text{} floor ( CURRENT\_slot \times 10 / ( numberOfSlotsPerFrame \times periodicity ) ) * M + i ] modulo nrofHARQ - Processes .$$

In the case that an offset (e.g., harq-ProcID-Offset as specified in 3GPP standard documents) is configured in the SPS configuration (in other words, for configured downlink assignments with harq-ProcID-Offset), the BS may determine the HPN of the DL transmission (e.g., the HARQ Process ID associated with a slot where the DL transmission starts) according to the following procedure.

If CURRENT_slot−floor (CURRENT_slot/periodicity)*periodicity is larger than or equal to a sum of values of first i periodicities within the time window and smaller than a sum of values of first i+1 periodicities within the time window,

$$HARQ Process ID = [ \text{} floor ( CURRENT\_slot \times 10 / ( numberOfSlotsPerFrame \times periodicity ) ) * M + i ] modulo nrofHARQ - Processes + harq - Proc ID - Offset .$$

In the above cases, HARQ Process ID is the HPN; CURRENT_slot=[(SFN×numberOfSlotsPerFrame)+slot number in the frame], wherein SFN is a system frame number of a system frame associated with the DL transmission, numberOfSlotsPerFrame refers to the number of consecutive slots per frame as specified in TS 38.211, slot number in the frame refers to a number of a slot where the DL transmission starts; periodicity is the length of the time window; M is the number of periodicities included in the time window; i is a value from 0 to M−1; nrofHARQ-Processes is the number of HARQ processes configured in the SPS configuration; harq-ProcID-Offset is the offset configured in the SPS configuration.

### Embodiments II

In embodiments II, the reference parameter may be a value of one periodicity of the at least two periodicities.

In some embodiments, the one periodicity may be the first periodicity in the time domain in the at least two periodicities.

In some other embodiments, the BS may transmit RRC signaling or DCI (e.g., including an indication) indicating the one periodicity from the at least two periodicities to the UE.

In some other embodiments, the one periodicity is a periodicity with a smallest value in the at least two periodicities.

In some other embodiments, the one periodicity is a periodicity with a largest value in the at least two periodicities.

### Embodiments III

In embodiments III, the BS may transmit an indication indicating a value as the reference parameter from the BS. For example, for the UL transmission, the value indicated by the BS may be in units of symbols. For the DL transmission, the value indicated by the indication may be in units of slots. The value indicated by the BS may be the same as the value of one periodicity in the at least two periodicities or may be different from values of all periodicities of the at least two periodicities.

In some embodiments, the value indicated by the BS may have relationship with at least one periodicity in the at least two periodicities. For example, the value may be a value of one periodicity in the at least two periodicities plus an offset.

The following embodiments provide methods regarding how to use the reference parameter determined in embodiments II or embodiments III to determine the HPN for the UL transmission or for the DL transmission.

### Embodiments 1

In embodiments 1, for the UL transmission corresponding to the CG configuration, the HPN may be determined as follows.

In the case that an offset (e.g., harq-ProcID-Offset2 as specified in 3GPP standard documents) and a retransmission timer (e.g., cg-RetransmissionTimer as specified in 3GPP standard documents) are not configured in the CG configuration (in other words, for configured uplink grants neither configured with harq-ProcID-Offset2 nor with cg-RetransmissionTimer), the UE may determine the HPN of the UL transmission (e.g., HARQ Process ID associated with the first symbol of the UL transmission) based on the following equation.

$$HARQ Process ID = [ \text{} floor ( CURRENT\_symbol / periodicity ) ] modulo nrofHARQ - Processes .$$

In the case that an offset (e.g., harq-ProcID-Offset2 as specified in 3GPP standard documents) is configured in the CG configuration (in other words, for configured uplink grants configured with harq-ProcID-Offset2), the UE may determine the HPN of the UL transmission (e.g., HARQ Process ID associated with the first symbol of the UL transmission) according to the following equation.

$$HARQ Process ID = [ floor ( CURRENT\_symbol / periodicity ) ] modulo nrofHARQ - Processes + harq - ProcID - Offset 2.$$

In the above cases, HARQ Process ID is the HPN; CURRENT_symbol=(SFN×numberOfSlotsPerFrame×numberOfSymbolsPerSlot+slot number in the frame×numberOfSymbolsPerSlot+symbol number in the slot), wherein SFN is a system frame number of a system frame associated with the UL transmission, numberOfSlotsPerFrame refers to the number of consecutive slots per frame, numberOfSymbolsPerSlot refer to the number of consecutive symbols per slot, slot number in the frame refers to a number of a slot associated with the UL transmission, and symbol number in the slot refers to a number of the first symbol of the UL transmission; periodicity is the reference parameter which is determined based on the methods in embodiments II or embodiments III; nrofHARQ-Processes is the number of HARQ processes configured in the CG configuration; and harq-ProcID-Offset2 is the offset configured in the CG configuration.

### Embodiments 2

In embodiments 2 for the DL transmission corresponding to the SPS configuration, the HPN may be determined as follows.

In the case that an offset (e.g., harq-ProcID-Offset as specified in 3GPP standard documents) is not configured in the SPS configuration (in other words, for configured downlink assignments without harq-ProcID-Offset), the UE may determine the HPN of the DL transmission (e.g., the HARQ Process ID associated with a slot where the DL transmission starts) according to the following equation.

$$HARQ Process ID = [ \text{} floor ( CURRENT\_slot \times 10 / ( numberOfSlotsPerFrame \times periodicity ) ) ] modulo nrofHARQ - Processes .$$

In the case that an offset (e.g., harq-ProcID-Offset as specified in 3GPP standard documents) is configured in the SPS configuration (in other words, for configured downlink assignments with harq-ProcID-Offset), the UE may determine the HPN of the DL transmission (e.g., the HARQ Process ID associated with a slot where the DL transmission starts) according to the following equation.

$$HARQ Process ID = [ \text{} floor ( CURRENT\_slot \times 10 / ( numberOfSlotsPerFrame \times periodicity ) ) ] modulo nrofHARQ - Processes + harq - ProcID - Offset .$$

In the above cases, HARQ Process ID is the HPN; CURRENT_slot=[(SFN×numberOfSlotsPerFrame)+slot number in the frame], wherein SFN is a system frame number of a system frame associated with the DL transmission, numberOfSlotsPerFrame refers to the number of consecutive slots per frame, slot number in the frame refers to a number of a slot where the DL transmission starts; periodicity is the reference parameter which is determined based on the methods in embodiments II or embodiments III; nrofHARQ-Processes is the number of HARQ processes configured in the SPS configuration; harq-ProcID-Offset is the offset configured in the CG configuration.

In some cases, using the reference parameter determined based on the methods in embodiments II or embodiments III to determine the HPN for UL transmission or DL transmission may bring some issues, which may refer to FIG. 10 as stated above. The following embodiments may provide several methods to solve the above problem.

According to some embodiments of the present application, the BS may transmit an HPN offset to the UE. Alternatively, the HPN offset may be preconfigured (e.g., fixed in the 3GPP standard documents). In such embodiments, determining the HPN for the UL transmission or the DL transmission may include determining the HPN for the UL transmission or the DL transmission by using the HPN offset. The methods for using the HPN offset to determine the HPN may refer to the following embodiments.

### Embodiments 3

In embodiments 3, for the UL transmission, the equation in embodiments 1 may change as follows.

In the case that an offset (e.g., harq-ProcID-Offset2 as specified in 3GPP standard documents) and a retransmission timer (e.g., cg-RetransmissionTimer as specified in 3GPP standard documents) are not configured in the CG configuration (in other words, for configured uplink grants neither configured with harq-ProcID-Offset2 nor with cg-RetransmissionTimer), the BS may determine the HPN of the UL transmission (e.g., HARQ Process ID associated with the first symbol of the UL transmission) based on the following equation.

$$HARQ Process ID = [ floor ( CURRENT\_symbol / periodicity ) ] modulo nrofHARQ - Processes + HPN offset .$$

In the case that an offset (e.g., harq-ProcID-Offset2 as specified in 3GPP standard documents) is configured in the CG configuration (in other words, for configured uplink grants configured with harq-ProcID-Offset2), the BS may determine the HPN of the UL transmission (e.g., HARQ Process ID associated with the first symbol of the UL transmission) according to the following equation.

$$HARQ Process ID = [ floor ( CURRENT\_symbol / periodicity ) ] modulo nrofHARQ - Processes + harq - ProcID - Offset 2 + HPN offset .$$

In the above cases, HPN offset is transmitted by the BS or pre-configured as stated above, the other parameters may have the same definitions as in embodiments 1.

### Embodiments 4

In embodiments 4, for the DL transmission, the equation in embodiments 2 may change as follows.

In the case that an offset (e.g., harq-ProcID-Offset as specified in 3GPP standard documents) is not configured in the SPS configuration (in other words, for configured downlink assignments without harq-ProcID-Offset), the BS may determine the HPN of the DL transmission (e.g., the HARQ Process ID associated with a slot where the DL transmission starts) according to the following equation.

$$HARQ Process ID = [ \text{} floor ( \text{} CURRENT\_slot \times 10 / ( numberOfSlotsPerFrame \times periodicity ) ) ] modulo nrofHARQ - Processes + HPN offset .$$

In the case that an offset (e.g., harq-ProcID-Offset as specified in 3GPP standard documents) is configured in the SPS configuration (in other words, for configured downlink assignments with harq-ProcID-Offset), the UE may determine the HPN of the DL transmission (e.g., the HARQ Process ID associated with a slot where the DL transmission starts) according to the following equation.

$$HARQ Process ID = [ \text{} floor ( \text{} CURRENT\_slot \times 10 / ( numberOfSlotsPerFrame \times periodicity ) ) ] modulo nrofHARQ - Processes + harq - Proc ID - Offset + HPN offset .$$

In the above cases, HPN offset is transmitted by the BS or pre-configured as stated above, the other parameters may have the same definitions as in embodiments 2.

In some embodiments of the present application, the HPN offset configured or pre-configured to the UE may be associated with an HPN periodicity. In such embodiments, determining the HPN for the UL transmission or the DL transmission may include determine the HPN for the UL transmission or the DL transmission by using the HPN offset according to the HPN periodicity. For example, the BS may use the HPN offset (e.g., using the HPN offset as shown in the equations in embodiments 3 and 4) once every HPN periodicity to determine HPN. In other times, the BS may use the equations in embodiments 1 and 2 to determine HPN.

According to some other embodiments of the present application, the BS may transmit a set of HPN offsets associated with a set of periodicities to the UE. Alternatively, the set of HPN offsets may be preconfigured. Each periodicity of the set of periodicities is associated with an HPN offset in the set of HPN offsets. In such embodiments, determining the HPN for the UL transmission or the DL transmission may include determining the HPN for the UL transmission or the DL transmission by using an HPN offset in the set of HPN offsets which is associated with a periodicity in which the UL transmission or the DL transmission is located. The methods for using the HPN offset to determine the HPN may refer to the following embodiments.

### Embodiments 5

In embodiments 5, for the UL transmission, the equation in embodiments 1 may change as follows.

In the case that an offset (e.g., harq-ProcID-Offset2 as specified in 3GPP standard documents) and a retransmission timer (e.g., cg-RetransmissionTimer as specified in 3GPP standard documents) are not configured in the CG configuration (in other words, for configured uplink grants neither configured with harq-ProcID-Offset2 nor with cg-RetransmissionTimer), the BS may determine the HPN of the UL transmission (e.g., HARQ Process ID associated with the first symbol of the UL transmission) based on the following equation.

$$HARQ Process ID = [ floor ( CURRENT\_symbol / periodicity ) ] modulo nrofHARQ - Processes + HPN offset .$$

In the case that an offset (e.g., harq-ProcID-Offset2 as specified in 3GPP standard documents) is configured in the CG configuration (in other words, for configured uplink grants configured with harq-ProcID-Offset2), the BS may determine the HPN of the UL transmission (e.g., HARQ Process ID associated with the first symbol of the UL transmission) according to the following equation.

$$HARQ Process ID = [ floor ( CURRENT\_symbol / periodicity ) ] modulo nrofHARQ - Processes + harq - ProcID - Offset 2 + HPN offset .$$

In the above cases, HPN offset is an HPN offset in the set of HPN offsets which is associated with a periodicity in which the UL transmission is located, the other parameters may have the same definitions as in embodiments 1.

### Embodiments 6

In embodiments 6, for the DL transmission, the equation in embodiments 2 may change as follows.

In the case that an offset (e.g., harq-ProcID-Offset as specified in 3GPP standard documents) is not configured in the SPS configuration (in other words, for configured downlink assignments without harq-ProcID-Offset), the BS may determine the HPN of the DL transmission (e.g., the HARQ Process ID associated with a slot where the DL transmission starts) according to the following equation.

$$HARQ Process ID = [ floor ( CURRENT\_slot \times 10 / ( numberOfSlotsPerFrame \times periodicity ) ) ] modulo nrofHARQ - Processes + HPN offset .$$

In the case that an offset (e.g., harq-ProcID-Offset as specified in 3GPP standard documents) is configured in the SPS configuration (in other words, for configured downlink assignments with harq-ProcID-Offset), the BS may determine the HPN of the DL transmission (e.g., the HARQ Process ID associated with a slot where the DL transmission starts) according to the following equation.

$$HARQ Process ID = [ floor ( CURRENT\_slot \times 10 / ( numberOfSlotsPerFrame \times periodicity ) ) ] modulo nrofHARQ - Processes + harq - Proc ID - Offset + HPN offset .$$

In the above cases, HPN offset is an HPN offset in the set of HPN offsets which is associated with a periodicity in which the DL transmission is located, the other parameters may have the same definitions as in embodiments 2.

According to some other embodiments of the present application, the BS may receive an HPN indication for the UL transmission from the UE. The HPN indication may indicate an HPN determined by the UE. For example, HPN determined by the UE may be different from an HPN determined based on a method (e.g., the method in Embodiments 1) used by both the BS and the UE.

In some embodiments, the HPN indication for the UL transmission may be included in CG-UCI. In some embodiments, the HPN indication for the UL transmission may be received in a time domain position configured for the UE or transmitted according to a reporting periodicity configured for the UE.

According to some other embodiments of the present application, the BS may transmit an HPN indication for the DL transmission to the UE before the DL transmission. The HPN indication may indicate an HPN determined by the BS. For example, the HPN determined by the BS may be different from an HPN determined based on a method (e.g., the method in Embodiments 2) used by both the BS and the UE. For example, the BS may determine a first HPN for the DL transmission based on the methods in embodiments 2. However, the BS may also determine that the first HPN is not correct and determine a correct HPN for the DL transmission. In such embodiments, the BS may transmit an HPN indication for the DL transmission to the UE, the HPN indication may indicate the correct HPN.

In some embodiments, the HPN indication for the DL transmission may be transmitted in a time domain position configured for the UE or received according to an indicating periodicity configured for the UE.

According to some embodiments of the present application, the BS may determine the HPN for the UL transmission based on a number of the last symbol in a periodicity including the first symbol of the UL transmission, or determine the HPN for the DL transmission based on a number of the last slot in a periodicity including a slot where the DL transmission starts. The examples for using the last symbol to determine the HPN for the UL transmission or using the last slot to determine the HPN for the DL transmission may be as follows.

For example, for the UL transmission corresponding to the CG configuration, the BS may still use the equations in embodiments 1 to determine the HPN. However, the definition of the CURRENT_symbol may change. For example, the CURRENT_symbol may equal a number of the last symbol in a periodicity including the first symbol of the UL transmission.

In another example, for the DL transmission corresponding to the SPS configuration, the BS may still use the equations in embodiments 2 to determine the HPN. However, the definition of the CURRENT_slot may change. For example, the CURRENT_slot may equal a number of the last slot in a periodicity including a slot where the DL transmission starts.

After determining the HPN for the UL transmission, in step 1505, the BS may receive the UL transmission based on the HPN from the UE. Alternatively, after determining the HPN for the DL transmission, in step 1505, the BS may transmit the DL transmission based on the HPN to the UE.

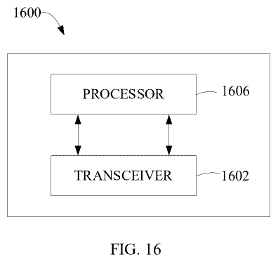

FIG. 16 illustrates a simplified block diagram of an exemplary apparatus for determining an HPN according to some embodiments of the present application. As shown in FIG. 16, the apparatus 1600 may include at least one processor 1606 and at least one transceiver 1602 coupled to the processor 1606. The apparatus 1600 may be a UE or a BS.

Although in this figure, elements such as the at least one transceiver 1602 and processor 1606 are described in the singular, the plural is contemplated unless a limitation to the singular is explicitly stated. In some embodiments of the present disclosure, the transceiver 1602 may be divided into two devices, such as a receiving circuitry and a transmitting circuitry. In some embodiments of the present disclosure, the apparatus 1600 may further include an input device, a memory, and/or other components.

In some embodiments of the present disclosure, the apparatus 1600 may be a UE. The transceiver 1602 and the processor 1606 may interact with each other so as to perform the operations with respect to the UE described in FIGS. 1-15. In some embodiments of the present disclosure, the apparatus 1600 may be a BS. The transceiver 1602 and the processor 1606 may interact with each other so as to perform the operations with respect to the BS described in FIGS. 1-15.

In some embodiments of the present disclosure, the apparatus 1600 may further include at least one non-transitory computer-readable medium.

For example, in some embodiments of the present disclosure, the non-transitory computer-readable medium may have stored thereon computer-executable instructions to cause the processor 1606 to implement the method with respect to the UE as described above. For example, the computer-executable instructions, when executed, cause the processor 1606 interacting with transceiver 1602 to perform the operations with respect to the UE described in FIGS. 1-15.

In some embodiments of the present disclosure, the non-transitory computer-readable medium may have stored thereon computer-executable instructions to cause the processor 1606 to implement the method with respect to the BS as described above. For example, the computer-executable instructions, when executed, cause the processor 1606 interacting with transceiver 1602 to perform the operations with respect to the BS described in FIGS. 1-15.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A. B. or both A and B. The wording “the first.” “the second” or the like is only used to clearly illustrate the embodiments of the present disclosure, but is not used to limit the substance of the present disclosure.

1. A user equipment (UE) for wireless communication, comprising:
at least one memory; and
at least one processor coupled with the at least one memory and configured to cause the UE to:
determine at least two periodicities with different values for a configured grant (CG) configuration or a semi-persistent scheduling (SPS) configuration;
determine a hybrid automatic repeat request (HARQ) process number (HPN) for an uplink (UL) transmission corresponding to the CG configuration or a downlink (DL) transmission corresponding to the SPS configuration based at least in part on a reference parameter; and
transmit the UL transmission based at least in part on the HPN, or receive the DL transmission based at least in part on the HPN.

2. The UE of claim 1, wherein the at least two periodicities with different values are in a time window, and the reference parameter is a length of the time window.

3. The UE of claim 1, wherein the at least two periodicities with different values are in a time window, and the reference parameter is a number of periodicities included in the time window.

4. The UE of claim 3, wherein a length of the time window is in units of symbols, and wherein to determine the HPN for the UL transmission, the at least one processor is further configured to cause the UE to:
determine the time window including a first symbol of the UL transmission;
determine a periodicity including the first symbol of the UL transmission within the time window; or
determine the HPN based on the periodicity including the first symbol of the UL transmission.

5. The UE of claim 4, wherein to determine the HPN for the UL transmission, the at least one processor is further configured to cause the UE to:
in a case that an offset and a retransmission timer are not configured in the CG configuration, determine the HPN for the UL transmission based on:
if CURRENT_symbol−floor (CURRENT_symbol/periodicity)*periodicity is larger than or equal to a sum of values of first i periodicities within the time window and smaller than a sum of values of first i+1 periodicities within the time window, then HARQ Process ID=[floor (CURRENT_symbol/periodicity)*M+i] modulo nrofHARQ-Processes; and
in a case that an offset is configured in the CG configuration, determine the HPN based on:
if CURRENT_symbol−floor (CURRENT_symbol/periodicity)*periodicity is larger than or equal to a sum of values of first i periodicities within the time window and smaller than a sum of values of first i+1 periodicities within the time window, then HARQ Process ID=[floor (CURRENT_symbol/periodicity)*M+i] modulo nrofHARQ-Processes+harq-ProcID-Offset2;
wherein:
HARQ Process ID is the HPN;
CURRENT_symbol=(SFN×numberOfSlotsPerFrame×numberOfSymbolsPerSlot+slot number in a frame×numberOfSymbolsPerSlot+symbol number in the slot), wherein the SFN is a system frame number of a system frame associated with the UL transmission, the numberOfSlotsPerFrame refers to a number of consecutive slots per frame, the numberOfSymbolsPerSlot refer to a number of consecutive symbols per slot, the slot number in the frame refers to a number of a slot associated with the UL transmission, and the symbol number in the slot refers to a number of the first symbol of the UL transmission;
the periodicity is the length of the time window;
the M is a number of periodicities included in the time window;
the i is a value from 0 to M−1;
the nrofHARQ-Processes is a number of HARQ processes configured in the CG configuration; and
the harq-ProcID-Offset2 is an offset configured in the CG configuration.

6. The UE of claim 3, wherein a length of the time window is in units of slots, and wherein to determine the HPN for the DL transmission, the at least one processor is further configured to cause the UE to:
determine the time window including a slot where the DL transmission starts;
determine a periodicity including the slot where the DL transmission starts; or
determine the HPN based on the periodicity including the slot where the DL transmission starts.

7. The UE of claim 6, wherein to determine the HPN for the DL transmission, the at least one processor is further configured to cause the UE to:
in a case that an offset is not configured in the SPS configuration, determine the HPN based on:
if CURRENT_slot−floor (CURRENT_slot/periodicity)*periodicity is larger than or equal to a sum of values of first i periodicities within the time window and smaller than a sum of values of first i+1 periodicities within the time window, then HARQ Process ID=[floor (CURRENT_slot×10/(numberOfSlotsPerFrame×periodicity))*M+i] modulo nrofHARQ-Processes; and
in a case that an offset is configured in the SPS configuration, determine the HPN based on:
if CURRENT_slot−floor (CURRENT_slot/periodicity)*periodicity is larger than or equal to a sum of values of first i periodicities within the time window and smaller than a sum of values of first i+1 periodicities within the time window, then HARQ Process ID=[floor (CURRENT_slot×10/(numberOfSlotsPerFrame×periodicity))*M+i] modulo nrofHARQ-Processes+harq-ProcID-Offset;
wherein:
HARQ Process ID is the HPN;
CURRENT_slot=[(SFN×numberOfSlotsPerFrame)+slot number in a frame], wherein the SFN is a system frame number of a system frame associated with the DL transmission, the numberOfSlotsPerFrame refers to a number of consecutive slots per frame, the slot number in the frame refers to a number of a slot where the DL transmission starts;
the periodicity is the length of the time window;
the M is a number of periodicities included in the time window;
the i is a value from 0 to M−1;
the nrofHARQ-Processes is a number of HARQ processes configured in the SPS configuration; and
the harq-ProcID-Offset is an offset configured in the SPS configuration.

8. The UE of claim 1, wherein the reference parameter is a value of one periodicity of the at least two periodicities.

9. The UE of claim 8,
wherein the one periodicity is a first periodicity in a time domain in the at least two periodicities;
wherein the at least one processor is further configured to cause the UE to receive radio resource control (RRC) signaling or downlink control information (DCI) indicating the one periodicity from the at least two periodicities;
wherein the one periodicity is a periodicity with a smallest value in the at least two periodicities; or
wherein the one periodicity is a periodicity with a largest value in the at least two periodicities.

10. The UE of claim 1, wherein the at least one processor is further configured to cause the UE to receive an indication indicating a value as the reference parameter.

11. The UE of claim 1, wherein the at least one processor is further configured to cause the UE to obtain an HPN offset configured or preconfigured for the UE; and
determine the HPN for the UL transmission or the DL transmission by using the HPN offset.

12. The UE of claim 1, wherein the at least one processor is further configured to cause the UE to:
obtain a set of HPN offsets associated with a set of periodicities; and
determine the HPN for the UL transmission or the DL transmission by using an HPN offset in the set of HPN offsets which is associated with a periodicity in which the UL transmission or the DL transmission is located.

13. The UE of claim 1, wherein the at least one processor is further configured to cause the UE to transmit an HPN indication for the UL transmission to a base station (BS) or receive an HPN indication for the DL transmission from the BS,
wherein the HPN indication for the UL transmission is transmitted in a time domain position configured for the UE or transmitted according to a reporting periodicity configured for the UE; or
wherein the HPN indication for the DL transmission is received in a time domain position configured for the UE or received according to an indicating periodicity configured for the UE.

14. A base station (BS) for wireless communication, comprising:
at least one memory; and
at least one processor coupled with the at least one memory and configured to cause the BS to:
determine at least two periodicities with different values for a configured grant (CG) configuration or a semi-persistent scheduling (SPS) configuration;
determine a hybrid automatic repeat request (HARQ) process number (HPN) for an uplink (UL) transmission corresponding to the CG configuration or a downlink (DL) transmission corresponding to the SPS configuration based at least in part on a reference parameter; and
receive the UL transmission based at least in part on the HPN, or transmit the DL transmission based at least in part on the HPN.

15. A method performed by a user equipment (UE), the method comprising:
determining at least two periodicities with different values for a configured grant (CG) configuration or a semi-persistent scheduling (SPS) configuration;
determining a hybrid automatic repeat request (HARQ) process number (HPN) for an uplink (UL) transmission corresponding to the CG configuration or a downlink (DL) transmission corresponding to the SPS configuration based at least in part on a reference parameter; and
transmitting the UL transmission based at least in part on the HPN or receiving the DL transmission based at least in part on the HPN.

16. The method of claim 15, wherein the at least two periodicities with different values are in a time window, and the reference parameter is a length of the time window.

17. The method of claim 15, further comprising:
obtaining a set of HPN offsets associated with a set of periodicities; and
determine the HPN for the UL transmission or the DL transmission by using an HPN offset in the set of HPN offsets which is associated with a periodicity in which the UL transmission or the DL transmission is located.

18. A processor for wireless communication, comprising:
at least one controller coupled with at least one memory and configured to cause the processor to:
determine at least two periodicities with different values for a configured grant (CG) configuration or a semi-persistent scheduling (SPS) configuration;
determine a hybrid automatic repeat request (HARQ) process number (HPN) for an uplink (UL) transmission corresponding to the CG configuration or a downlink (DL) transmission corresponding to the SPS configuration based at least in part on a reference parameter; and
transmit the UL transmission based at least in part on the HPN, or receive the DL transmission based at least in part on the HPN.

19. The processor of claim 18, wherein the at least two periodicities with different values are in a time window, and the reference parameter is a length of the time window.

20. The processor of claim 18, wherein the at least one controller is further configured to cause the processor to:
obtain a set of HPN offsets associated with a set of periodicities; and
determine the HPN for the UL transmission or the DL transmission by using an HPN offset in the set of HPN offsets which is associated with a periodicity in which the UL transmission or the DL transmission is located.
